(19) United States
(12) Patent Application Publication
(10) Pub. No.: US 2023/0231142 A1
(43) Pub. Date: Jul. 20, 2023

(54) FUNCTIONALIZED CROSS-LINKED POLYMER NETWORKS, METHODS OF MAKING SAME, AND USES THEREOF

(71) Applicant: CORNELL UNIVERSITY, Ithaca, NY (US)

(72) Inventors: Lynden A. Archer, Ithaca, NY (US); Sanjuna Stalin, Perungu (IN)

(21) Appl. No.: 17/927,784

(22) PCT Filed: Jun. 1, 2021
(86) PCT No.: PCT/US2021/035274

§ 371 Date: Nov. 25, 2022

Related U.S. Application Data
(60) Provisional application No. 63/032,616, filed on May 30, 2020.

(51) Int. Cl. H01M 4/62; H01M 4/134; H01M 10/0525; C08G 75/045; C09D 181/02

(52) U.S. Cl. CPC H01M 4/628; H01M 4/134; H01M 10/0525; C08G 75/045; C09D 181/02; H01M 2004/027

(57) ABSTRACT

In various examples, a functionalized cross-linked polymer network includes a plurality of cross-linked multifunctional trione triazine groups, a plurality of disulfide groups, a plurality of cross-linked multifunctional ether groups, a plurality of cross-linked multifunctional polyether groups, or a combination thereof, a plurality of crosslinking multifunctional polyether groups, and a plurality of dangling groups, where individual cross-linked multifunctional trione triazine groups and/or cross-linked multifunctional disulfide groups and/or cross-linked multifunctional ether groups and/or cross-linked multifunctional polyether groups and individual crosslinking multifunctional polyether groups are connected by one or more covalent bond(s) and individual dangling groups may be connected to the network by a covalent bond. At least a portion of or all of the dangling groups may be halogenated. A functionalized cross-linked polymer network may be made by polymerization (e.g., Thiol-ene reach on(s)) of one or more functionalized monomer(s) and one or more multifunctional monomer(s).

### CROSS-REFERENCE TO RELATED APPLICATIONS

This application claims the benefit of U.S. provisional application Ser. No. 63/032,616 filed May 30, 2020, the entire disclosure of which is hereby incorporated by reference in its entirety.

### STATEMENT REGARDING FEDERALLY SPONSORED RESEARCH

This invention was made with government support under contract no. IIP-1919013 awarded by the National Science Foundation. The government has certain rights in the invention.

### BACKGROUND OF THE DISCLOSURE

Safe, cost-effective, and long-lasting electrical energy storage devices are important to sustain progress in electrified transportation, mobile device technology, and autonomous machines including drones and advanced robotics. Over the last two decades, rechargeable lithium ion batteries (LIBs) have emerged as a dominant technology in this growing commercial space because their lightweight, low self-discharge rates, and high energy density have provided levels of reliability and portability required for application of energy storage (EES) technology in multiple commercial sectors. The success of LIBs as the EES technology for powering electric vehicles (EVs) have, nonetheless, revealed multiple drawbacks of the technology that are expected to become more problematic as electrification makes greater inroads in the global transportation fleet. Among these limitations, the low specific energy (SELIB=0.2-0.25 kWh/kg) relative to practical values achievable in an internal combustion engine burning commercial grade gasoline (SE≈2 kWh), is considered the most important for the EV application. The USABC has, for example, set cell-level energy density and specific energy targets of 750 Wh/L and 350 Wh/kg, respectively, that batteries must meet to power electric vehicles entering the marketplace in 2020. The LiC6/(LiMn₂O₄—LiNiO₂) LIBs that power the Nissan Leaf provide a cell-level specific energy of 140 Wh/kg, less than half this target, while the LiC6/NCA cells used in the Tesla Model S offer a maximum energy density of 232 Wh/kg. None of the LIB designs in current use can meet USABC long-term goals.

A pathway to create EES technology for substantially higher specific energy and range is through transforming today's LIBs to so-called ‘metal batteries’, in which the graphitic carbon anode is replaced with a metal block or foil composed of lithium or zinc. These batteries are attractive because they achieve higher anode capacity (by a factor ranging from 2 to 7) and enable use of higher-energy conversion cathodes, including sulfur and oxygen, for even larger enhancements in SE. Scalable approaches for overcoming fundamental challenges associated with morphological, chemical, and hydrodynamic instabilities at metal anode have emerged in recent years to be crucial for progress. No electrochemical cell design presently exists that addresses all these challenges.

Fundamental understanding of the formation mechanisms, mechanical stability, ion transport characteristics, and interfacial properties of solid-electrolyte interphases (SEI), typically formed spontaneously at battery anodes, though in its infancy is considered a requirement for progress. This is easily traced to the role such interphases are known to play in the exceptional reversibility of the graphite anode in contemporary lithium-ion batteries, as well as in the typically less impressive reversibility of the metal anodes used in emergent Li and alkaline Zn battery technology.

Reactive metal anodes are known to electrodeposit in the form irregular morphological features on planar substrates. Formed during the earliest stages of deposition, these features are thought to seed non-planar, mossy structures that proliferate in the electrode spacing, hampering electrode reversibility. A growing body of work suggests that the mechanics, structure, ion transport properties, reductive stability, and interfacial energy of interphases formed spontaneously on the metal electrode play important, but differentiated roles in regulating nucleation, growth, and reversibility of these non-planar structures.

The propensity of the Li metal anode to form non-planar, mossy structures (loosely termed dendrites) during battery recharge has been widely investigated in the literature. It has been postulated that the formation of Li dendrites occurs in three main stages: The first stage involves the formation of a passivation layer by reduction of electrolyte components (such as solvents, salts, or additives) in contact with the metallic anode. Termed the solid electrolyte interphase (SEI), this layer has been investigated by means of focused ion beam (FIB) cryo-genic SEM and electron spectroscopy techniques, and shown to be highly heterogeneous and far thicker than the analogous SEI formed on graphite anodes in lithium ion batteries (LIBs). In the second stage, the heterogeneity of the SEI leads to hot spots with higher conductivity that nucleate the growth of dendrites, subsequently leading to convergence of electric field lines at the peaks of the nucleated dendrites that further facilitate their growth. Finally, the passivation layer continuously breaks and reforms by reaction with the electrolyte, promoting continuous growth of the dendrite into a ramified structure with the growth direction determined by the least reactive crystallographic facet of metallic Li.

Several approaches have been investigated to mitigate or, in rarer cases completely prevent the growth of lithium dendrites. These include salt additives to improve the properties of the SEI, concentrated electrolytes that change the solvation structure of the ions and resulting SEI formation, single ion conductors that prevent concentration gradients in the bulk electrolyte phase and high modulus electrolytes that prevent dendrite formation via mechanical pressure forces. Tailoring the lithium metal/electrolyte interface with polymer coatings that serve as a protective barrier against chemical and physical instabilities has been gaining a lot of attention in the past few years. Ease of processability and freedom in tuning the properties of the polymer has boosted recent studies on using self-healing polymers, crosslinked polymers, composites, single ion conducting polymers, and fluoropolymers for enabling high rate and high-capacity deposition of lithium. Very few studies have attempted to elucidate how to design such polymer coatings; these include studying polymer coatings of different chemistries and physical properties and using tools like coarse grained molecular modeling. Parameters like the surface energy, dielectric permittivity and relaxation time of the polymer segments were found to have impact on the deposition of lithium metal.

It is generally considered that fluorinated interphases enhance the reversibility of Li metal anodes and, in aprotic carbonate electrolytes are important for long term cycling stability of the Li anode, particularly in cases where the Li capacity in the battery anode and cathode are nearly balanced. This has motivated multiple studies aimed at understanding the intrinsic physical and electrochemical characteristics of SEI enriched with lithium fluoride and other fluorinated compounds. A key finding is that while fluoride-enriched interphases are beneficial for improving electrode reversibility in short-term cycling studies at low Li discharge capacities, unless the interphases possess an intrinsic mechanism to heal, they are insufficient for achieving long-term reversible cycling of a Li anode.

### SUMMARY OF THE DISCLOSURE

The present disclosure describes functionalized cross-linked polymer networks. The present disclosure also provides methods of making functionalized cross-linked polymer networks and uses thereof.

In an aspect, the present disclosure provides functionalized cross-linked polymer networks. In various examples, a functionalized cross-linked polymer network comprises a plurality of cross-linked multifunctional groups (which may be cross-linked multifunctional trione triazine group(s), cross-linked multifunctional disulfide group(s), cross-linked multifunctional ether group(s), cross-linked multifunctional polyether group(s), or the like, or a combination thereof); and a plurality of crosslinking multifunctional polyether groups(s); and a plurality of functional groups (which may be alternatively referred to as functional side chains, side chains, functional dangling groups, or dangling groups). The individual cross-linked multifunctional groups and individual crosslinking multifunctional polyether groups(s) are connected by at least one covalent bond (e.g., crosslinking group). The covalent bond may be a thioether bond (e.g., carbon-sulfur bond or carbon-sulfur-carbon bond). Individual crosslinking multifunctional polyether groups(s) may comprise one or more functional group(s). The individual functional groups may be covalently bonded to individual crosslinking multifunctional polyether groups by a thioether bond. A functionalized cross-linked polymer network may be a halogenated (e.g., fluorinated) cross-linked polymer network. A functionalized cross-linked polymer network may be a film (e.g., a continuous film). A functionalized cross-linked polymer network (which may be a continuous film (e.g., a continuous film) may be disposed on a metal substrate, which may be an anode.

In an aspect, the present disclosure provides methods of making functionalized cross-linked polymer networks. In various examples, a method of making a functionalized cross-linked polymer network coating on a metal substrate comprises: forming a coating on a substrate comprising: one or more functionalized monomer(s), the functionalized monomer(s) independently comprising one or more functional groups and/or one or more reactive group(s) (e.g., two or more reactive group(s)) one or more multifunctional monomer(s) comprising two or more reactive groups and, optionally, one or more functional group(s), optionally, one or more polymerization initiator(s), and optionally, one or more solvent(s); exposing the coating to electromagnetic radiation, in the case where the coating comprises one or more photoinitiator(s), and/or heating the coating and/or allowing the coating to stand under ambient conditions to initiate a reaction of the one or more functionalized monomer(s) and the one or more multifunctional monomer(s), where the functionalized cross-linked polymer network is formed. Functionalized monomer(s), multifunctional monomer(s), optionally, polymerization initiator(s), and optionally, solvent(s) may be combined prior to formation of the coating in a coating composition or coating mixture. A coating composition/mixture may be used to form a coating, which may be disposed on a substrate or anode. A reaction may be photoinitiated, thermally initiated, redox initiated, catalyzed, or the like or any combination thereof to initiate a reaction of the precursor(s) (e.g., functionalized monomer(s) and multifunctional monomer(s).

In an aspect, the present disclosure provides anodes. The anodes comprise one or more functionalized cross-linked polymer network(s) of the present disclosure and/or one or more functionalized cross-linked polymer network(s) made by a method of the present disclosure. An anode may be a reversible anode. In various examples, an anode, which may be an anode for a metal ion-conducting electrochemical device, comprises a metal member; a coating, which may be a continuous coating, disposed on at least a portion of the metal (e.g., all portions of the metal member that would be or are in contact with the electrolyte of the metal ion-conducting electrochemical device) comprising one or more functionalized cross-linked polymer network(s) of the present disclosure. A coating may be made by a method of the present disclosure. Various metal members can be used. Non-limiting examples of metal members include lithium metal members, sodium metal members, potassium metal members, magnesium metal members, aluminum metal members, and the like. The anode may comprise a current collector other than the anode material(s) (e.g., conducting coating(s) and/or metal member(s)).

In an aspect, the present disclosure provides devices. The devices may comprise one or more functionalized cross-linked polymer network(s) of the present disclosure and/or one or more functionalized cross-linked polymer network(s) made by a method of the present disclosure and/or one or more anode(s) of the present disclosure. The one or more functionalized cross-linked polymer network(s) may be formed in situ in the device. The devices may be electrochemical devices.

### BRIEF DESCRIPTION OF THE FIGURES

For a fuller understanding of the nature and objects of the disclosure, reference should be made to the following detailed description taken in conjunction with the following figures.

FIG. 1 shows a synthesis scheme of a fluorinated cross-linked polymer.

FIG. 2A-2B shows Nuclear Magnetic Resonance (NMR) spectrometry results confirming tethering of fluorinated side chains to a crosslinker. (2A) NMR spectra of unreacted starting materials of FIG. 1 (first step), a 3T3F monomer, a 3T7F monomer, and a 3T10F monomer. (2B) NMR spectrum of the crosslinker functionalized with 3T10F sidechain(s) (see, final product of FIG. 1 (first step)).

FIGS. 3A-3C shows an effect of polymer coating thickness on Li⁺ ion transport: (3A) Impedance spectra for polished electrodes with different coating thickness in combination with bulk electrolyte (1M LiPF₆ in EC/DMC). (3B) Extracted bulk, coating and charge transfer resistances. (3C) Temperature dependent measurements fitted with VFT equation and corresponding activation energies.

FIGS. 4A-4B shows Fourier-Transform Infrared (FTIR) spectra confirming disappearance of (4A) SH and (4B) C═C peaks upon crosslinking of monomers in the different thicknesses of the samples.

FIGS. 5A-5B shows voltage profiles for galvanostatic deposition at a current density J=1 mA/cm² on coated electrodes with different coating thicknesses paired against (5A) a carbonate (1M LiPF₆ in EC/DMC) and (5B) ether (1M LiTFSI in diglyme) based electrolyte.

FIGS. 6A-6C shows an effect of fluorinated coating thickness on early stage growth of lithium metal: (6A) SEM images of deposits following nucleation event for two classes of electrolyte and different thicknesses of the fluorinated polymer coating. (6B) Nucleation overpotential measured under galvanostatic conditions for the two electrolytes as a function of coating thickness. (6C) The average deposit sizes for each coating thickness obtained by first analyzing the full-size distribution using the ImageJ program, from which the mean value (points) and variance (error bars) were determined. Additional prior art data set for Self-Healing Polymer has been included for comparison.

FIGS. 7A-7E shows distribution maps for radius of nuclei for deposition of lithium for (7A) a control; and under (7B) 0.2 μm, (7C) 2 μm, (7D) 10 μm, and (7E) 100 μm of fluorinated polymer coating in carbonate electrolyte.

FIGS. 8A-8E shows distribution maps for radius of nuclei for deposition of lithium for (8A) a control; and under (8B) 0.2 μm, (8C) 2 μm, (8D) 10 μm, and (8E) 100 μm of fluorinated polymer coating in ether-based electrolyte (1M LiTFSI in diglyme).

FIGS. 9A-9B shows half-wavelength of the fastest growing mode as a function of coating thickness for various values of diffusivity contrast between a coating and a liquid, in the case of (9A) Gs=0.5 MPa and (9B) Gs=1 MPa.

FIGS. 10A-10C shows an effect of surface energy of polymer coating thickness on early stage growth of lithium metal: (10A) Structures of Lithion™ and monomers used to functionalize thiol crosslinkers with different lengths of fluorinated sidechains. (10B) SEM images of lithium deposits (0.1 mAh/cm² @ 1 mA/cm² with carbonate electrolyte in bulk phase) under 3T3F, Lithion™, 3T7F and 3T10F from left to right respectively. (10C) Nuclei sizes for each case obtained from image analysis and surface energies calculated using contact angle measurements.

FIG. 11 shows Differential Scanning Calorimetry (DSC) of networks formed with different crosslinkers. Legend indicates glass transition temperatures obtained from analysis of curves.

FIGS. 12A-12C shows an effect of current density on nuclei radius and corresponding distribution maps for deposition of lithium under different thicknesses of fluoro polymer coating (carbonate electrolyte): (12A) 1 mA/cm²; (12B) 5m A/cm²; and (12C) 10 mA/cm².

FIG. 13 shows SEM images of sodium metal galvanostatically deposited on an uncoated and coated polished stainless-steel current collector (current density=0.5 mA/cm² capacity=0.1 mAh/cm²). Electrolyte used is 1M NaPF₆ in EC/DMC.

FIG. 14 shows oscillatory shear measurements depicting storage (filled symbols) and loss (open symbols) modulus of fluorinated and ether-based polymer coatings. The coating thickness was 100 μm and a small strain of 0.1% was employed for the measurement.

FIG. 15 shows impedance spectroscopy showing interfacial impedance of ether based PEGDMA coating.

FIGS. 16A-16D shows visualization and characterization of lithium deposition in growth regime: (16A) Snapshots of Li electrodeposit morphology taken from optical visualization studies using interphases with different effective surface energies. (16B) Growth rates extracted from time-dependent evolution for the three systems in (16A), compared with expectations for a completely planar (i.e. the Li deposit has the theoretical density of bulk Li metal) Li deposit. Note: the error bars in the figure records variations in the deposit height (i.e. the electrodeposit) roughness, which is substantially reduced using polymer interphases of essentially any chemistry. (16C) SEM images of electrode surface and evolution of lithium deposit morphology with increasing modulus of interfacial layer for no coating, ether (PEGDMA) based coating and fluorinated (3T10F) based coating from left to right. (16D) Grazing Incidence X-Ray Diffraction (GIXRD) analysis of Li deposited on bare stainless steel (SS) substrate (left) and on stainless steel substrate coated with the fluorinated (3T10F) polymer interphase material (right).

FIGS. 17A-17E shows electrochemical stability and efficiency of fluorinated polymer coating: (17A) Impedance of cells with coated electrodes measured after potentiostatic holds for different periods of time. (17B) Impedance of cells with bare electrodes measured after potentiostatic holds for different periods of time. (17C) Extracted interfacial impedance values for coated and uncoated electrodes after performing chronoamperometry measurements. (17D) Coulombic efficiency of cells with and without coated electrodes in a carbonate electrolyte (current density-0.5 mA/cm², capacity-1 mAh/cm²). (17E) Coulombic efficiency of cells with and without coated electrodes in an ether based electrolyte (current density-0.5 mA/cm², capacity-1 mAh/cm²).

FIG. 18A-18D shows a voltage profiles for coulombic efficiency tests with and without coatings on current collector for two classes of electrolytes.

FIG. 19 shows capacity of lithium stripped and corresponding coulombic efficiency with a 3T10F coating on current collector for 1M LiPF₆ in EC/DMC with 10% (Vol) FEC as bulk electrolyte

FIGS. 20A-20B. (20A) shows capacity vs cycle number and (20B) Voltage profiles for the tenth cycle for full cells with and without 3T10F coating on current collector for IM LiPF₆ in EC/DMC with 10% (Vol) FEC as bulk electrolyte and NCM 622 (3.5 mAh/cm²) as the cathode.

FIGS. 21A-21C shows AFM imaging of a fluorinated polymer coating of varying thicknesses: (21A) 0.2 μm, (21B) 2 μm, and (21C) 100 μm.

FIG. 22 shows Cryo-Fib imaging of lithium deposit under fluorinated polymer coating.

FIG. 23 shows examples of multifunctional monomers used to create coatings with varying shear modulus values.

### DETAILED DESCRIPTION OF THE DISCLOSURE

Although claimed subject matter will be described in terms of certain examples, other examples, including examples that do not provide all of the benefits and features set forth herein, are also within the scope of this disclosure. Various structural, logical, and process step changes may be made without departing from the scope of the disclosure.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent radicals, trivalent radicals, and the like). Illustrative examples of groups include:

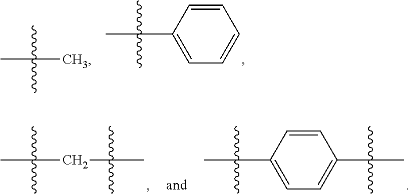

The present disclosure describes functionalized cross-linked polymer networks. The present disclosure also provides methods of making functionalized cross-linked polymer networks and uses thereof.

The present disclosure describes polymeric networks with functional groups, the functional groups which may be alternatively referred to as functional side chains, side chains, functional dangling groups, or dangling groups. These materials may be applied as a coating on a metal anode (e.g., lithium metal anode) of a rechargeable battery. In various examples, the resultant coating has shown evidence of stabilizing lithium metal deposition and enabling planar deposit and display Li plating/striping efficiencies, for example, exceeding 98% when paired with a suitable liquid electrolyte at the cathode.

The present disclosure also describes coatings based on cross-linked polymeric membranes formed on or transferred to a metal anode. The coatings may provide desirable mechanical and ion transport properties and prevent formation of morphological and chemical instabilities that cause dendritic deposition notoriously associated with these metal anodes.

Without intending to be bound by any particular theory, it is considered that a cross-linked polymer network of the present disclosure can increase the interfacial energy of the electrode/electrolyte interphase which enables planar, non-dendritic deposition of, for example, lithium, sodium, potassium, magnesium, aluminum, or the like. In various examples, when paired with a suitable electrolyte, these systems display Li plating/striping efficiencies exceeding 98%.

In an aspect, the present disclosure provides functionalized cross-linked polymer networks. In various examples, a functionalized cross-linked polymer network is made by a method of the present disclosure. In various examples, a functionalized cross-linked polymer network is not a hyperbranched polymer. Non-limiting examples of functionalized cross-linked polymer networks are provided herein.

In various examples, a functionalized cross-linked polymer network comprises (consists essentially of or consists of) a plurality of cross-linked multifunctional groups (e.g., cross-linked multifunctional trione triazine group(s), cross-linked multifunctional disulfide group(s), cross-linked multifunctional ether group(s), cross-linked multifunctional polyether group(s), and the like, and combinations thereof); a plurality of crosslinking multifunctional polyether groups (which may be alternatively referred to as cross-linked crosslinking multifunctional polyether groups); and a plurality of functional groups (which may be alternatively referred to as functional side chains, side chains, functional dangling groups, or dangling groups). The individual functional groups (or at least a portion thereof) may be connected by at least one covalent bond (e.g., covalently bonded) to the network (e.g., a cross-linked multifunctional group and/or a crosslinking multifunctional polyether group). The functional groups (or at least a portion thereof) may be connected by at least one covalent bond (e.g., covalently bonded) to cross-linked multifunctional groups (e.g., cross-linked multifunctional trione triazine group(s), cross-linked multifunctional disulfide group(s), cross-linked multifunctional ether group(s), cross-linked multifunctional polyether group(s), or the like, or a combination thereof) and/or crosslinking multifunctional polyether groups. In various other examples, a functionalized cross-linked polymer network comprises (consists essentially of or consists of) a plurality of cross-linked multifunctional groups (e.g., multifunctional trione triazine group(s), multifunctional disulfide group(s), multifunctional ether group(s), multifunctional polyether group(s), and the like, and combinations thereof); and a plurality of crosslinking multifunctional polyether group(s)), each comprising one or more functional group(s). The individual cross-linked multifunctional groups (or least a portion thereof) and individual crosslinking multifunctional polyether groups(s) (or at least a portion thereof) are connected by at least one covalent bond (e.g., crosslinking group) or an average of at least one covalent bond (e.g., crosslinking group). The covalent bond(s) may be thioether bond(s). The covalent bond(s) may be formed by Thiol-ene reaction(s).

A multifunctional group may be structurally derived from (or formed from) a monomer. A cross-linked multifunctional group may be structurally derived (or formed from) a multifunctional monomer. A crosslinking polyether group may be structurally derived from (or formed from) a functional monomer.

A functionalized cross-linked polymer network can comprise various functional groups. A functional group may not be part of (e.g., incorporated in or the like) the polymer backbone of the functionalized cross-linked polymer network. Combinations of functional groups may be used. Non-limiting examples of functional groups include halogenated groups (e.g., groups comprising one or more fluorine group(s), one or more chlorine group(s), one or more bromine groups(s), one or more iodine group(s), or a combination thereof), polyethylene glycol group(s), polydimethyl siloxane (PDMS) groups, and the like, and combinations thereof. A halogenated group may be a perhalogenated group. In various examples, a polyethylene glycol group has a molecular weight of 250-1,000 g/mol, including all 0.1 g/mol values and ranges therebetween. A functional group may be covalently bonded to the network (e.g., cross-linked multifunctional groups(s) groups and/or crosslinking multifunctional polyether group(s) or the remainder of the cross-linked multifunctional groups(s) groups and/or crosslinking multifunctional polyether group(s)) by a thioether group (e.g., a carbon-sulfur bond or a carbon-sulfur-carbon bond).

A functionalized cross-linked polymer network may be a halogenated (e.g., fluorinated or the like) cross-linked polymer network. In various examples, functional group(s) of a functionalized cross-linked network is/are halogenated (e.g., fluorinated or the like) alkyl group(s) are independently chosen from halogenated (e.g., fluorinated or the like) C₁-C₆ alkyl groups. The halogenated (e.g., fluorinated or the like) alkyl groups may have various degrees of halogenation (e.g., fluorination or the like). A halogenated (e.g., fluorinated or the like) alkyl group may comprise (or be) a halogenated (e.g., fluorinated or the like) alkyl group. A halogenated (e.g., fluorinated or the like) alkyl group or groups may be covalently bonded to the crosslinking multifunctional polyether groups(s) (or the remainder of the crosslinking multifunctional polyether groups(s) groups) by a thioether group (e.g., a carbon-sulfur bond or carbon-sulfur-carbon bond).

A cross-linked multifunctional group may be a cross-linked multifunctional trione triazine group (e.g., a 1,3,5-triazine-2,4,6(1H,3H,5H)-trione group or the like). A 1,3,5-triazine-2,4,6(1H,3H,5H)-trione group may be formed from a 1,3,5-triazine-2,4,6(1H,3H,5H)-trione monomer comprising various numbers of reactive groups, which may react to form a crosslinking group with a reactive group of a functionalized polyether monomer. A cross-linked multifunctional group may comprise (or be) a cross-linked multifunctional trione triazine group, a cross-linked multifunctional disulfide group (e.g.,

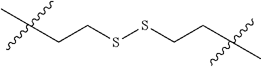 [SMILES: *CCSSCC*]

or the like), a cross-linked multifunctional ether group (e.g.,

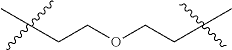 [SMILES: *CCOCC*]

or the like), or a cross-linked multifunctional polyether group (e.g.,

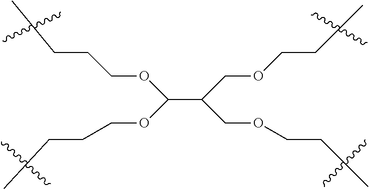 [SMILES: *CCCOC(OCCC*)C(COCC*)COCC*]

or the like), or the like.

In various examples, a functionalized cross-linked polymer network comprises a plurality of cross-linked 1,3,5-triazine-2,4,6(1H,3H,5H)-trione groups having the following structure:

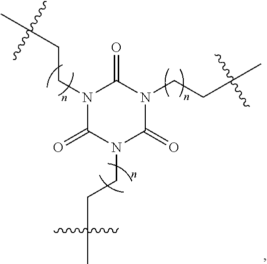

where n is independently 1-6 (e.g., 1, 2, 3, 4, 5, or 6), or a plurality of cross-linked disulfide groups having the following structure:

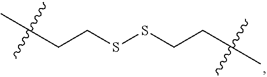 [SMILES: *CCSSCC*]

or a plurality of cross-linked ether groups having the following structure:

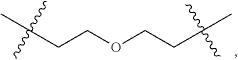 [SMILES: *CCOCC*]

or a plurality of cross-linked polyether groups having the following structure

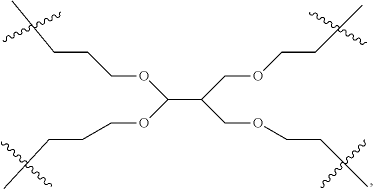 [SMILES: *CCCOC(OCCC*)C(COCC*)COCC*]

or a combination thereof, and/or the crosslinking multifunctional polyether groups(s) groups independently comprising one or more (e.g., 1, 2, or 3) functional group(s) have the following structure:

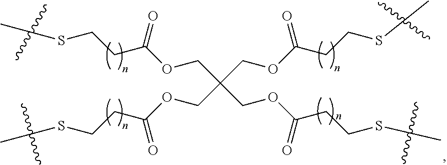

where n is independently 1-4, and independently at least one sulfur (S) (e.g., 1 S, 2 S, or 3 S) is covalently bonded to a functional group (e.g., a halogenated group (e.g., group comprising one or more fluorine group(s), one or more chlorine group(s), one or more bromine group(s), one or more iodine group(s), or a combination thereof), which may be a per-halogenated group, a polyethylene glycol group, a polydimethyl siloxane (PDMS) group, or the like).

A functionalized cross-linked polymer network may comprise one or more unreacted reactive groups. In various examples, a functionalized cross-linked polymer network comprises 10% or less, 5% or less, 1% or less, or 0.5% or less unreacted reactive groups (e.g., unreacted thiol, alkenyl groups, etc.).

A functionalized cross-linked polymer network may be a film. A functionalized cross-linked polymer network film may be a continuous film.

A functionalized cross-linked polymer network (which may be a film (e.g., a continuous film)) may be disposed on a metal substrate. In various examples, a functionalized cross-linked polymer network (which may be a film (e.g., a continuous film)) is disposed on at least a portion of or all of an exterior surface of a metal (which may be a metal member or an anode). A metal may be any metal, metal alloy, or the like, that is typically used in electronic devices. Non-limiting examples of metals include lithium metal, sodium metal, potassium metal, magnesium metal, aluminum metal, and the like. In various examples, a functionalized cross-linked polymer network is alternatively referred to as a fluorinated polymer coating.

In various examples, a functionalized cross-linked polymer network exhibits one or more desirable propert(ies). In various examples, a functionalized cross-linked polymer network exhibits a shear modulus of 100-0.1 MPa (e.g., 50-1 MPa, 10-1 MPa, etc.), including all 0.1 MPa values and ranges therebetween and/or a tan 6 of 1:50 to 1:1, including all 0.1 values and ranges therebetween. The shear modulus and/or tan 6 can be measured by methods known in the art. Non-limiting examples of suitable methods are described herein.

In an aspect, the present disclosure provides methods of making functionalized cross-linked polymer networks. Non-limiting examples of methods of making functionalized cross-linked polymer networks are described herein.

In various examples, a method of making a functionalized cross-linked polymer network coating on a metal substrate comprises (consists essentially of or consists of): forming a coating on a substrate comprising: one or more functionalized monomer(s), one or more multifunctional monomer(s), optionally, one or more polymerization initiator(s), and optionally, one or more solvent(s); exposing the coating to electromagnetic radiation, in the case where the coating comprises one or more photoinitiator(s), and/or heating the coating and/or allowing the coating to stand under ambient conditions to initiate a reaction of the one or more functionalized monomer(s) and the one or more multifunctional monomer(s), where the functionalized cross-linked polymer network is formed. The individual functionalized monomer(s) comprise one or more functional group(s) and/or one or more reactive group(s) (e.g., two or more reactive group(s)). The individual multifunctional monomer(s) comprise one or more functional group(s) and/or two or more reactive groups.

In various examples, a method of making a functionalized cross-linked polymer network coating on a metal substrate comprises (consists essentially of or consists of): forming a coating on a substrate comprising: one or more functionalized monomer(s), the functionalized monomer(s) independently comprising one or more functional groups and one or more reactive group(s) (e.g., two or more reactive group(s)), one or more multifunctional monomer(s) comprising two or more reactive groups, optionally, one or more polymerization initiator(s), and optionally, one or more solvent(s); exposing the coating to electromagnetic radiation, in the case where the coating comprises one or more photoinitiator(s), and/or heating the coating and/or allowing the coating to stand under ambient conditions to initiate a reaction of the one or more functionalized monomer(s) and the one or more multifunctional monomer(s), where the functionalized cross-linked polymer network is formed.

Functionalized monomer(s), multifunctional monomer(s), optionally, polymerization initiator(s), and optionally, solvent(s) may be combined prior to formation of the coating in a coating composition or coating mixture. A coating composition/mixture may be used to form a coating, which may be disposed on a substrate or anode.

A functionalized polymer network may be synthesized in two steps. In various examples, a crosslinker is functionalized with one or more functional group(s) and the network then formed by UV polymerization of the monomers in the presence of a photoinitiator.

Various functionalized monomers (which may be alternatively referred to as functionalized crosslinking monomer(s) or crosslinker(s)) can be used. Combinations of functionalized monomers may be used. A functionalized monomer may comprise (or be functionalized with) one or more functional group(s). Non-limiting examples, of functional groups include halogenated groups (e.g., groups comprising one or more fluorine group(s), one or more chlorine group(s), one or more bromine group(s), one or more iodine group(s), or a combination thereof, which may be halogenated alkyl groups, such as, for example, fluorinated alkyl groups), polyethylene glycol group, polydimethyl siloxane (PDMS) groups, and the like, and combinations thereof. A functionalized monomer may comprise one or more reactive group(s) (e.g., two or more reactive group(s)). In various examples, a functionalized monomer comprises 1, 2, or 3 reactive groups. Non-limiting examples of reactive groups include alkenyl groups, thiol groups, and the like, and combinations thereof. A functionalized monomer may be a halogenated crosslinking monomer. Non-limiting examples of halogenated monomers include fluorinated monomers, and the like, and combinations thereof.

A functionalized monomer may comprise one or more reactive group(s) (e.g., two or more reactive group(s)) (e.g., thiol group(s) and/or one or more alkenyl group(s)). Examples of thiol groups include, but are not limited to, acylthiol groups (e.g.,

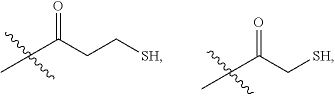 [SMILES: *C(=O)CCS ; *C(=O)CS]

and the like), alkylthiol groups (e.g.,

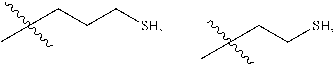

and the like), and the like. Examples of alkenyl groups include, but are not limited to,
alkyl alkenyl groups (e.g.,

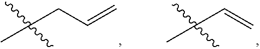

and the like), acyl alkenyl groups (e.g.,

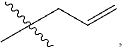 [SMILES: *CC=C]

and the like), cycloalkenyl groups (e.g.,

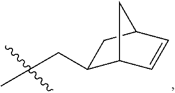 [SMILES: *CC1CC2C=CC1C2]

and the like.

A functionalized monomer may be a functionalized polyether crosslinking monomer (such as, for example, a functionalized pentaerythritol monomer or the like). A functionalized polyether crosslinking monomer may be alternatively referred to as a functionalized polyether monomer. In various examples, the one or more functionalized monomer(s) is/are chosen from

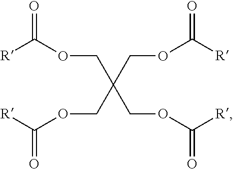

where R′ is independently chosen from functional groups, thiol groups, and alkenyl groups, and 1, 2, or 3 R′ groups are functional groups.

In various examples, a functionalized monomer is a tetra functional thiol monomer (e.g., pentaerythritol tetrakis(3-mercaptopropionate), which may be capped off at one or more end(s) through a base catalyzed thiol-Michael addition reaction with an acrylate functionalized monomer. In various examples, a functionalized monomer is formed from perfluoro alkyl acrylate (2,2,3,3,4,4,5,5,6,6,7,7-Dodecafluoroheptyl acrylate), ethyl 2-(bromomethyl)acrylate, poly(ethylene glycol) methyl ether acrylate, methacryloxypropyl terminated polydimethylsiloxane, or the like, or a combination thereof. This is then used as a multifunctional (e.g., tri-functional) functionalized monomer and crosslinks with, for example, a multifunctional monomer, such as, for example, 1,3,5-triallyl-1,3,5-triazine-2,4,6(1H,3H,5H)-trione, under UV light in the presence of a photoinitiator.

Various multifunctional monomers can be used. Various multifunctional monomers may alternatively be referred to as a multifunctional crosslinking monomer. Combinations of multifunctional monomers may be used. A multifunctional monomer(s) may comprise two or more reactive group(s). A multifunctional monomer(s) may not comprise a functional group. In various examples, a multifunctional monomer comprises two reactive groups or three reactive groups. Non-limiting examples of reactive groups include alkenyl groups, thiol groups, and the like, and combinations thereof. Examples of thiol groups include, but are not limited to, acylthiol groups (e.g.,

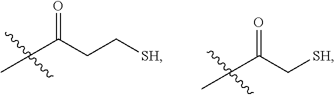 [SMILES: *C(=O)CCS ; *C(=O)CS]

and the like), alkylthiol groups (e.g.,

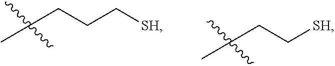

and the like), and the like, and combinations thereof. Examples of alkenyl groups include, but are not limited to, alkyl alkenyl groups (e.g.,

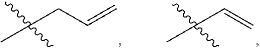

and the like), acyl alkenyl groups (e.g.,

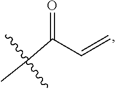 [SMILES: *C(=O)C=C]

and the like), cycloalkenyl groups (e.g.,

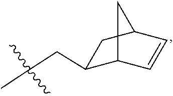 [SMILES: *CC1CC2C=CC1C2]

and the like), and the like, and combinations thereof. A multifunctional monomer(s) may comprise one or more functional group(s). A multifunctional monomer may comprise a halogenated functional group, such as, for example, a fluorinated crosslinking monomer.

In various examples, the one or more multifunctional monomer(s) are chosen from multifunctional trione triazine monomers (e.g.,

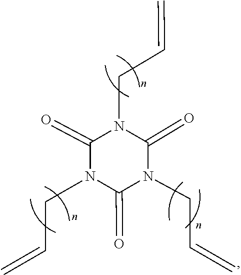

wherein n is independently 1, 2, 3, or 4), or the like), multifunctional disulfide monomers (e.g.,

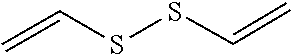

and the like), multifunctional ether monomers (e.g.,

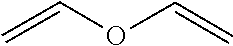

and the like), and multifunctional polyether monomers (e.g.,

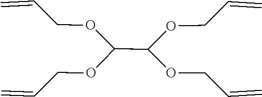 [SMILES: C=CCOC(OCC=C)C(OCC=C)OCC=C]

and the like), and the like, and combinations thereof.

A multifunctional crosslinking monomer may be a multifunctional crosslinking trione triazine monomer. In various examples, a multifunctional crosslinking trione triazine monomer (which may be a 1,3,5-triazine-2,4,6(1H,3H,5H)-trione monomer comprises three reactive groups (which may react with a reactive group of a functionalized polyether monomer to form a crosslink)), such as for example, terminal carbon-carbon double bonds. In various examples, the one or more multifunctional crosslinking monomer(s) is/are chosen from multifunctional 2,4,6-trione triazinanyl crosslinking monomer(s) (e.g.,

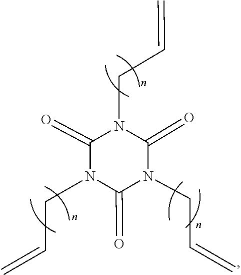

wherein n is independently 1, 2, 3, or 4, such as, for example,

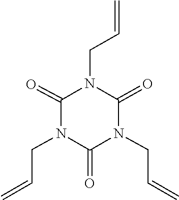 [SMILES: C=CCn1c(=O)n(CC=C)c(=O)n(CC=C)c1=O]

and the like).

In various examples, a method comprises first attaching one or more fluorinated acrylate monomer(s) to a thiol monomer, for example, by a Michael addition, to form functionalized thiol crosslinker(s), and subsequently the functionalized thiol crosslinker(s) is/are reacted with one or more azine monomer(s) to form functionalized monomer(s). These reactions may be carried out under ambient conditions and environment.

A functionalized monomer or multifunctional monomer may comprise (or be functionalized with) various reactive groups. A functionalized monomer or multifunctional monomer may comprise combinations of reactive groups. In various examples, where a monomer comprises two or more reactive groups, one or more of the reactive group(s) is/are structurally different that the remainder of the reactive groups. Non-limiting examples of reactive groups include alkenyl groups (such as, for example, terminal carbon-carbon double bonds and the like), thiol groups, and the like, and combinations thereof.

The precursor(s) (e.g., functionalized monomer(s), multifunctional monomer(s)) may react (e.g., in a polymerization reaction) to form a functionalized cross-linked polymer network. In various examples, a functionalized cross-linked polymer network is formed by reaction of 90% or more, 95% or more, 99% or more, or 99.5% or more of the precursor(s) (e.g., functionalized monomer(s) and/or multifunctional monomer(s)).

A polymerization may be photoinitiated, thermally initiated, redox initiated, catalyzed, or the like or any combination thereof to initiate a reaction of the precursor(s). A thermally initiated polymerization may include heating the precursor film (e.g., using an exogenous heating source) or holding the precursor film at ambient temperature (no exogenous heating source is used). A polymerization may be photoinitiated and thermally initiated.

A coating composition may comprise various polymerization initiator(s). Combinations of polymerization initiators may be used. In various examples, a coating composition comprises photoinitiator(s), thermal initiator(s), redox initiator(s), catalyst(s) (e.g., nucleophilic catalyst(s), base catalyst(s), and the like), or the like, or a combination thereof.

In the case of photoinitiated polymerizations (which may be ultraviolet polymerizations), various photoinitiators may be used. Combinations of two or more photoinitiators may be used. Suitable examples of photoinitiators are described herein. Non-limiting examples of UV photoinitiators include benzophenones, methylbenzyl formate, and the like. It is desirable that at least a portion or all of the electromagnetic radiation wavelength(s) to which the precursor coating composition (e.g., a film) is exposed are absorbed by the one or more photoinitiators(s). Non-limiting examples of photoinitiator(s) include alpha hydroxy ketones, alpha amino ketones, phenyl glyoxolates, benzyldimethyl ketone, diaryl ketones, aryl diketones, acyl phosphine oxides, 3-ketocoumarins, arylalkylketones, benzoin ethers, thioxanthones, quinones, hexaarylbiimidazoyls, oximes, and the like, and combinations thereof.

In the case of thermally initiated polymerizations, various thermal initiators may be used. Combinations of two or more thermal initiators may be used. Suitable examples of thermal initiators are described herein. Non-limiting examples of thermal initiators include diazoinitiators, peroxides, which may be symmetrical peroxides or asymmetrical peroxides, and the like, and combinations thereof.

In the case of redox initiated polymerizations, various redox initiators may be used. Combinations of two or more redox initiators may be used. Suitable examples of redox initiators are described herein. Non-limiting examples of redox initiators include peroxomonosulfates, peroxodisulftates, metal ion oxidants (e.g., Mn(III) compounds, Mn(VII) compounds, Ce(IV) compounds, Fe(II) compounds, Fe(III) compounds, Co(III) compounds, and the like), and the like, and combinations thereof.

Various solvents may be used. Combinations of solvents may be used. In various examples, the solvent(s) is/are chosen from organic solvents (such as, for example, toluene, chloroform, ethanol, and the like), and the like, and combinations thereof. Suitable examples of solvent(s) are described herein. A solvent may comprise one or more liquid electrolyte(s). Examples of liquid electrolytes are known in the art.

The substrate may be a sacrificial substrate. The substrate may be a metal (which may be a metal substrate). Non-limiting examples of metals include lithium metal, sodium metal, potassium metal, magnesium metal, aluminum metal, and the like.

In an aspect, the present disclosure provides anodes. The anodes comprise (consists essentially of or consists of) one or more functionalized cross-linked polymer network(s) of the present disclosure and/or one or more functionalized cross-linked polymer network(s) made by a method of the present disclosure. An anode may be a reversible anode. Non-limiting examples of anodes are described herein.

In various examples, an anode, which may be an anode for a metal ion-conducting electrochemical device, comprises (consists essentially of or consists of) a metal member; a coating, which may be a continuous coating, disposed on at least a portion of the metal (e.g., all portions of the metal member that would be or are in contact with the electrolyte of the metal ion-conducting electrochemical device) comprising (consisting essentially of or consisting of) one or more functionalized cross-linked polymer network(s) of the present disclosure. A coating may be made by a method of the present disclosure.

Various metal members can be used. Non-limiting examples of metal members include lithium metal members, sodium metal members, potassium metal members, magnesium metal members, aluminum metal members, and the like.

A coating (or the functionalized cross-linked polymer network(s)) can have various thicknesses. In various examples, the thickness of the coating (or functionalized cross-linked polymer network(s)) is 0.1 to 100 microns, including all 0.1 micron values and ranges therebetween. In various other examples, the thickness of the coating (or functionalized cross-linked polymer network(s)) is 1 micron to 30 microns or 5 to 15 microns. A thickness may be a dimension of the coating that is perpendicular to a longest dimension of the coating.

A coating may have various morphologies. In various examples, a coating (or the functionalized cross-linked polymer network(s)) do/does not comprise any observable crystalline domains. Crystalline domains may be observed by methods known in the art. The coating (or functionalized cross-linked polymer network(s)) may be amorphous.

In various examples, the anode(s) are part of a device. Non-limiting examples of devices are described herein and include secondary batteries or secondary cells, which may be rechargeable batteries. Non-limiting examples of secondary batteries and primary batteries include Li-ion batteries, Li metal batteries, sodium-ion batteries, sodium-metal batteries, and the like. In various examples, an anode does not exhibit metal orphaning. In various examples, an anode does not comprise a binder.

An anode may comprise a current collector other than the anode material(s) (e.g., conducting coating(s) and/or metal member(s)). In an example, an anode does not comprise a metal current collector. The anode may be free of other conducting materials (e.g., carbon-based conducting materials and the like).

In an aspect, the present disclosure provides devices. A device comprises one or more functionalized cross-linked polymer network(s) of the present disclosure and/or one or more functionalized cross-linked polymer network(s) made by a method of the present disclosure and/or one or more anode(s) of the present disclosure. Non-limiting examples of devices described herein.

Dendritic metal deposition (e.g., deposition of sodium metal, lithium metal, or the like) that causes cell failure and inefficiency may be addressed by coating an anode of a device with one or more functionalized polymer network of the present disclosure. Without intending to be bound by any particular theory, it is considered that a coating of the present disclosure can prevent dendritic metal deposition. In various examples, a device does not exhibit dendritic metal deposition.

A device may be an electrochemical device. Non-limiting examples of electrochemical devices include batteries, supercapacitors, fuel cells, electrolyzers, electrolytic cells, and the like.

In various examples, a device comprises one or more functionalized cross-linked polymer network(s) of the present disclosure. The one or more functionalized cross-linked polymer network(s) may be formed in situ in a device.

A device may comprise a liquid electrolyte or a solid electrolyte. Non-limiting examples of solid electrolytes include organic polymer electrolytes, organic polymer and salt electrolytes, and polymer-inorganic composite electrolytes, any of which may comprise nanoparticle fillers. Non-limiting examples of polymers include polyethylene oxide (PEO), poly-1,3-dioxolane (poly-DOL), and the like. In various examples, a liquid electrolyte comprises a liquid, chosen from carbonates (such as, for example, ethylene carbonate (EC), propylene carbonate (PC), fluorinated ethylene carbonates, vinylene carbonate (VC), dimethyl carbonate (DMC), ethyl methyl carbonate (EMC), diethyl carbonate (DEC), 1,2-dimethoxyethane (DME), and the like),

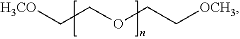

wherein n is 1, 2, or 3 (e.g., diglyme (DEGDME), tetraglyme (TEGDME), and the like), and the like, and combinations thereof.

A device may comprise metal ion salt. A metal ion of a metal ion salt may be a conducting metal ion of a device. Non-limiting examples of metal ion salts include lithium salts, sodium salts, potassium salts, aluminum salts, magnesium salts, ammonium salts, and the like, and combination thereof.

A device may be various batteries. Non-limiting examples of batteries include secondary/rechargeable batteries, primary batteries, and the like. A battery may be an ion conducting battery. Non-limiting examples of ion-conducting batteries include lithium-ion conducting batteries, potassium-ion conducting batteries, sodium-ion conducting batteries, magnesium-ion conducting batteries, aluminum-ion conducting batteries, iron-ion conducting batteries, and the like. A battery may be a metal battery, such as, for example, a lithium-metal battery, a sodium-metal battery, magnesium-metal battery, or the like. A device may be a solid-state battery or a liquid electrolyte battery. In the case where a device is a battery, the battery further may further comprise a cathode; and optionally, a separator.

A device, which may be an ion-conducting battery, may be an alkali metal- or alkaline earth metal-ion conducting liquid- or solid-state battery, where the anode comprises an alkali metal or alkaline earth metal. A device, which may be an ion-conducting battery, where the cathode may comprise a material chosen from alkali metal-containing, alkaline earth metal-containing, or conversion type cathode materials.

A device may be a lithium-ion conducting battery (which may be a solid-state lithium-ion conducting battery). It this case, the anode may comprise (or be) lithium metal, and the functionalized cross-linked polymer network(s) may be a lithium ion conductor or conductors. The cathode may comprise (or be) a material chosen from lithium-containing cathode materials. Non-limiting examples of lithium-containing cathode material include LiCoO₂, LiFePO₄, Li₂MMn₃O₈, where M is selected from Fe, Co, and combinations thereof, LiMn₂O₄, LiNiCoAlO₂, LiNiₓMn_{y}Co_{z}O₂, where x+y+z=1 (e.g., 0.5:0.3:0.2), and the like, and combinations thereof.

A device may be a sodium-ion conducting battery (which may be a solid-state sodium-ion conducting battery). In this case, the anode may comprise (or be) sodium metal, and the functionalized cross-linked polymer network(s) may be a sodium ion conductor or conductors. The cathode may comprise (or be) a material chosen from sodium-containing cathode materials and conversion type cathode materials. Non-limiting examples of sodium-containing cathode materials include Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄, and Na_{2/3}Fe_{1/2}Mn_{1/2}O₂@graphene composite, and the like, and combinations thereof.

A device may be a magnesium-ion conducting battery (which may be a solid-state magnesium-ion conducting battery). In this case, the anode may comprise (or be) is magnesium metal, and the functionalized cross-linked polymer network(s) may be a magnesium ion conductor or conductors.

In the case of a device, which may be a battery, comprising an anode material or anode of the present disclosure, the device may comprise one or more cathode(s), which may comprise one or more cathode material(s). Examples of suitable cathode materials are known in the art. In various examples, the cathode material(s) is/are one or more lithium-containing cathode material(s), one or more potassium-containing cathode material(s), one or more sodium-containing cathode material(s), one or more magnesium-containing cathode material(s), one or more aluminum-containing cathode material(s), or the like. Examples of suitable cathode materials are known in the art. Non-limiting examples of lithium-containing cathode materials include lithium nickel manganese cobalt oxides, LiCoO₂, LiNi_{1/3}Co_{1/3}Mn_{1/3}O₂, LiNi_{0.5}Co_{0.2}Mn_{0.3}O₂, lithium manganese oxides (LMOs), lithium iron phosphates (LFPs), LiMnPO₄, LiCoPO₄, and Li₂MMn₃O₈, where M is chosen from Fe, Co, and the like, and combinations thereof, and the like, and combinations thereof. Non-limiting examples of sodium-containing cathode materials include Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄, Na_{2/3}Fe_{1/2}Mn_{1/2}O₂@graphene composites, and the like, and combinations thereof. Non-limiting examples of magnesium-containing cathode materials include magnesium-containing materials (such as, for example, MgMSiO₄ (M is Fe, Mn, or Co) materials and MgFePO₄F materials, and the like), FeS₂ materials, MoS₂ materials, TiS₂ materials, and the like. In various examples, the magnesium-containing cathode materials are doped manganese oxides, and combinations thereof, and the like, and combinations thereof. Any of these cathodes/cathode materials may comprise a conducting carbon (e.g., a conducting carbon aid).

A device, which may be a battery, may comprise a conversion-type cathode. Non-limiting examples of conversion-type cathode materials include air (e.g., oxygen), iodine, sulfur, sulfur composite materials, polysulfides, metal sulfides, such as, for example, MoS₂, FeS₂, TiS₂, and the like, and combinations thereof.

A device, which may be a battery, may further comprise a solid electrolyte or liquid electrolyte. It may be desirable that the electrolyte by non-flammable (e.g., a non-flammable aqueous electrolyte). A battery may further comprise an aqueous or non-aqueous electrolyte. Examples of suitable electrolytes are known in the art. In various examples, a device, which may be a battery, comprises a liquid electrolyte, which is in contact with the functionalized cross-linked polymer network. Non-limiting examples of liquid electrolytes include LiPF₆ in EC/DMC, LiTFSI in EC/DMC, and the like.

A device may further comprise a current collector disposed on at least a portion of the anode(s). In various examples, the current collector is a conducting metal or metal alloy.

An electrolyte, a cathode, an anode of the present disclosure, and, optionally, the current collector may form a cell of a battery. The battery may comprise a plurality of the cells and each adjacent pair of the cells is separated by a bipolar plate. The number of cells in the battery is determined by the performance requirements (e.g., voltage output and the like) of the battery and is limited only by fabrication constraints. For example, the battery comprises 1 to 500 cells, including all integer number of cells and ranges therebetween.

The following Statements describe various examples of functionalized cross-linked polymer networks, methods of making functionalized cross-linked networks, anodes, and devices of the present disclosure.

Statement 1. A functionalized cross-linked polymer network comprising:

a plurality of cross-linked multifunctional groups (e.g., 1,3,5-triazine-2,4,6(1H,3H,5H)-trione groups and the like); and

a plurality of cross-linked crosslinking multifunctional polyether groups(s) (e.g., pentaerythritol tetrakis (mercaptoalkyl) groups, such as for example, pentaerythritol tetrakis (3-mercaptoprionate) groups), and the like) groups comprising one or more (e.g., 1, 2, or 3) functional groups (which may be alternatively referred to as “functional dangling” groups, etc.), wherein individual cross-linked multifunctional groups and individual crosslinking multifunctional polyether groups(s) are connected by at least one covalent bond. In various examples, a 1,3,5-triazine-2,4,6(1H,3H,5H)-trione group is structurally derived from (e.g., formed from) a 1,3,5-triazine-2,4,6(1H,3H,5H)-trione monomer comprising three functional groups (which may react to form a crosslinking group with a functional group of a multifunctional polyether monomer), such as for example, terminal carbon-carbon double bond.

Statement 2. A functionalized cross-linked polymer network according to Statement 1, wherein the cross-linked multifunctional group(s) are cross-linked 1,3,5-triazine-2,4,6(1H,3H,5H)-trione groups having the following structure:

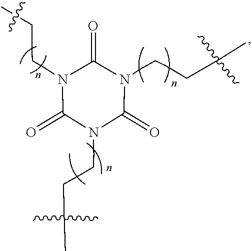

wherein n is independently 1-4 (e.g., 1, 2, 3, or 4), and/or the cross-linked crosslinking multifunctional polyether groups(s) groups independently comprising one or more (e.g., 1, 2, or 3) functional group(s) have the following structure:

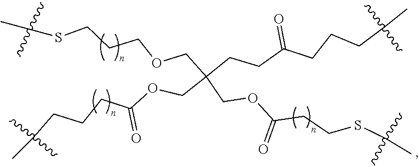

wherein n is independently 1-4, and independently at least one S (e.g., 1 S, 2 S, or 3 S) is covalently bonded to a functional group (e.g., a halogenated group (e.g., group comprising one or more fluorine group(s), one or more chlorine group(s), one or more bromine group(s), one or more iodine group(s), or a combination thereof), which may be a per-halogenated group, a polyethylene glycol group, a polydimethyl siloxane (PDMS) group, or the like). A functional group may be covalently bonded to the remainder of the crosslinking multifunctional polyether groups(s) groups by a thioether group (e.g., a carbon-sulfur bond). In various examples, a polyethylene glycol group has a molecular weight of 250-1,000 g/mol, including all 0.1 g/mol values and ranges therebetween.
Statement 3. A functionalized cross-linked polymer network according to Statement 1 or 2, wherein the functional group(s) is/are halogenated (e.g., fluorinated) alkyl group(s) are independently chosen from halogenated (e.g., fluorinated) C₁-C₆ alkyl groups.
Statement 4. A functionalized cross-linked polymer network according to any one of the preceding Statements, wherein the functionalized cross-linked polymer network exhibits a shear modulus of 100-0.1 MPa (e.g., 50-1 MPa, 10-1 MPa, etc.), including all 0.1 MPa values and ranges therebetween and/or a tan 5 of 1:50 to 1:1, including all 0.1 values and ranges therebetween.
Statement 5. A method of making a functionalized cross-linked polymer network (e.g., a functionalized cross-linked polymer network of any one of Statements 1-4) coating on a metal substrate comprising: forming a coating on a substrate comprising: one or more functionalized crosslinking monomer(s), the functionalized crosslinking monomer(s) independently comprising one or more functional groups (e.g., functional groups chosen from halogenated groups (e.g., groups comprising one or more fluorine group(s), one or more chlorine group(s), one or more bromine group(s), one or more iodine group(s), or a combination thereof, which may be halogenated alkyl groups, such as, for example, fluorinated alkyl groups), polyethylene glycol group(s), polydimethyl siloxane (PDMS) groups, and the like, and combinations thereof, and one or more reactive groups (e.g., 1, 2, or 3 reactive groups) chosen from alkenyl groups, thiol groups, and the like, and combinations thereof; one or more multifunctional monomer(s) comprising two or more (e.g., two reactive groups, three reactive groups, etc.) independently chosen from alkenyl groups, thiol groups, and the like, and combinations thereof; optionally, one or more polymerization initiator(s) (such as, for example, photoinitiator(s), thermal initiator(s), redox initiator(s), catalyst(s) (e.g., nucleophilic catalyst(s), base catalyst(s), and the like), and the like, and combinations thereof), and optionally, one or more solvent(s); exposing the coating to electromagnetic radiation, in the case where the coating comprises one or more photoinitiator(s), and/or heating the coating and/or allowing the coating to stand under ambient conditions to initiate a reaction of the one or more functionalized crosslinking monomer(s) and the one or more multifunctional monomer(s), wherein the functionalized cross-linked polymer network is formed.
Statement 6. A method according to Statement 5, wherein the photoinitiator(s) is/are chosen from alpha hydroxy ketones (e.g.,

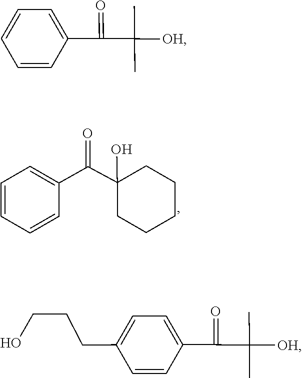 [SMILES: CC(C)(O)C(=O)c1ccccc1 ; O=C(c1ccccc1)C1(O)CCCCC1 ; CC(C)(O)C(=O)c1ccc(CCCO)cc1]

and the like), alpha amino ketones (e.g.,

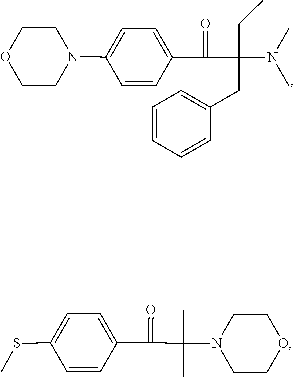

and the like), phenyl glyoxolates (e.g.,

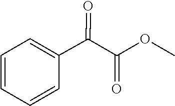

and the like), benzyldimethyl ketone, diaryl ketones (e.g.,

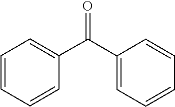 [SMILES: O=C(c1ccccc1)c1ccccc1]

and the like), aryl diketones (e.g.,

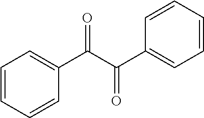 [SMILES: O=C(C(=O)c1ccccc1)c1ccccc1]

and the like), acyl phosphine oxides (e.g.,

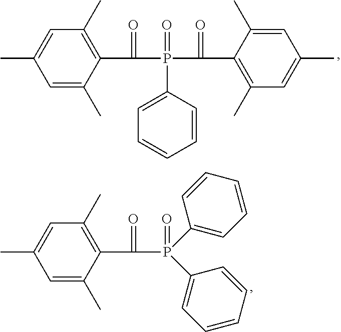

and the like), 3-ketocoumarins, arylalkylketones, benzoin ethers, thioxanthones, quinones, hexaarylbiimidazoyls, oximes, and the like, and combinations thereof, the thermal initiator(s) is/are chosen from diazoinitiators (e.g., R—N═N—R, wherein R is independently

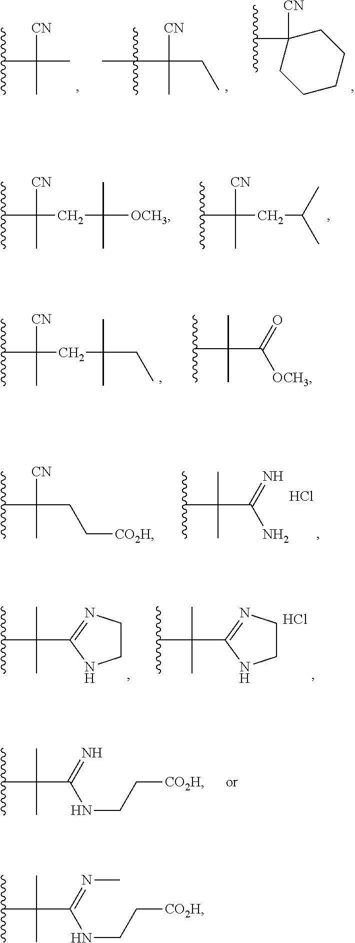

or the like), and the like, and combinations thereof,
peroxides, which may be symmetrical peroxides or asymmetrical peroxides (e.g., R—O—O—R, wherein R is independently

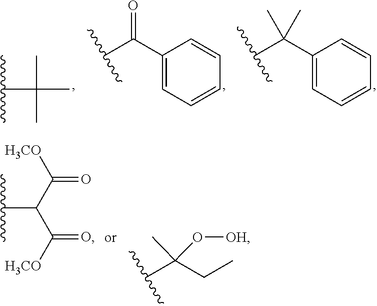

or the like. Examples of asymmetrical peroxides include, but are not limited to,

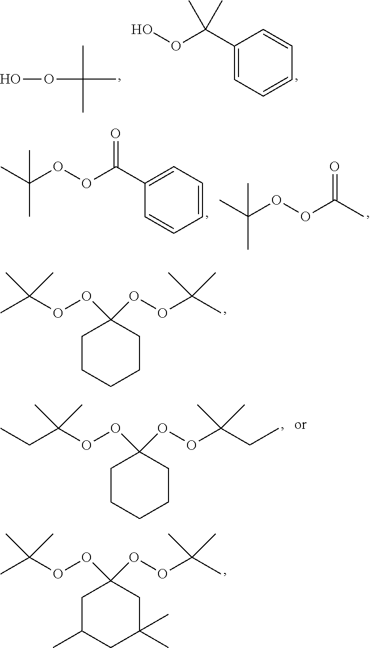

or the like), and the like, and combinations thereof, and
the redox initiator(s) is/are chosen from peroxomonosulfates, peroxodisulftates, metal ion oxidants (e.g., Mn(III) compounds, Mn(VII) compounds, Ce(IV) compounds, Fe(II) compounds, Fe(III) compounds, Co(III) compounds, and the like), and the like, and combinations thereof, and combinations thereof.
Statement 7. A method according to Statement 5 or 6, wherein the one or more functionalized crosslinking monomer(s) is/are chosen from

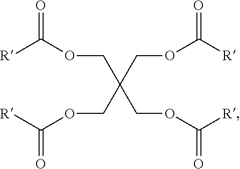

wherein R′ is independently chosen from functional groups, thiol groups, and alkenyl groups, and 1, 2, or 3 R′ groups are functional groups.
Statement 8. A method according to any one of Statements 5-7, wherein the one or more multifunctional crosslinking monomer(s) is/are chosen from multifunctional 2,4,6-trione triazinanyl crosslinking monomer(s) (e.g.,

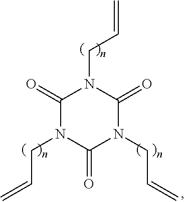

wherein n is independently 1, 2, 3, or 4, such as, for example,

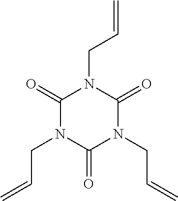 [SMILES: C=CCn1c(=O)n(CC=C)c(=O)n(CC=C)c1=O]

and the like).
Statement 9. A method according to any one of Statements 5-8, wherein the solvent is chosen from organic solvents (such as, for example, toluene, chloroform, ethanol, and the like), and the like, and combinations thereof.
Statement 10. An anode for a metal ion-conducting electrochemical device comprising (consisting essentially of or consisting of) a metal member; a coating, which may be a continuous coating, disposed on at least a portion of the metal (e.g., all portions of the metal member that would be or are in contact with the electrolyte of the metal ion-conducting electrochemical device) comprising a functionalized cross-linked polymer network of the present disclosure (e.g., a functionalized cross-linked polymer network of any one of claims 1-4).
Statement 11. An anode according to Statement 10, wherein the thickness of the functionalized cross-linked polymer network is 0.1 to 100 microns (e.g., 1 micron to 30 microns, 5 to 15 microns, etc.), including all 0.1 micron values and ranges therebetween.
Statement 12. An anode according to Statement 10 or 11, wherein the functionalized cross-linked polymer network does not comprise any observable crystalline domains.
Statement 13. A device comprising one or more functionalized cross-linked polymer network(s) of the present disclosure (e.g., of one of Statements 1-4, and/or one or more functionalized cross-linked polymer network(s) made by a method of any one of Statements 5-9, and/or one or more anode of any one of Statements 10-12).
Statement 14. A device according to Statement 13, wherein the device comprises a liquid electrolyte or a solid electrolyte.
Statement 15. A device according to Statement 14, wherein liquid electrolyte comprises a liquid, chosen from carbonates (such as, for example, ethylene carbonate (EC), propylene carbonate (PC), fluorinated ethylene carbonates (e.g., fluoroethylene carbonate (FEC),

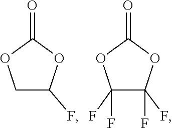

and the like), vinylene carbonate (VC), dimethyl carbonate (DMC), ethyl methyl carbonate (EMC), diethyl carbonate (DEC), 1,2-dimethoxyethane (DME), and the like),

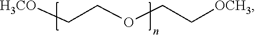

wherein n is 1, 2, or 3 (e.g., diglyme (DEGDME), tetraglyme (TEGDME), and the like), and the like, and combinations thereof, and/or
a lithium salt, a sodium salt, a potassium salt, an aluminum salt, a magnesium salt, an ammonium salt, or the like, or a combination thereof.
Statement 16. A device according to any one of Statements 13-15, wherein the device is a battery (e.g., an ion-conducting battery), a supercapacitor, or the like.
Statement 17. A device according to Statement 16, wherein the battery is a primary battery, secondary battery, or the like.
Statement 18. A device according to any one of Statements 13-17, wherein device is a battery and the battery further comprises: a cathode; and optionally, a separator.
Statement 19. A device according to Statement 18, wherein the device is a lithium-ion conducting battery, the anode comprise (is) lithium metal, and the functionalized cross-linked polymer network(s) may be a lithium ion conductor or conductors.
Statement 20. A device according to Statement 19, wherein the cathode comprises a material chosen from lithium-containing cathode materials.
Statement 21. A device according to Statement 19, wherein the device is a sodium-ion conducting solid-state battery, the anode comprises (or is) sodium metal, and the functionalized cross-linked polymer network(s) may be a sodium ion conductor or conductors.
Statement 22. A device according to Statement 21, wherein cathode comprises a material chosen from sodium-containing cathode materials and conversion type cathode materials.
Statement 23. A device according to Statement 19, wherein the device is a magnesium-ion conducting solid-state battery, the anode is magnesium metal, and the functionalized cross-linked polymer network(s) may be a magnesium ion conductor or conductors.
Statement 24. A device according to Statement 23, wherein cathode comprises a material chosen from magnesium-containing cathode materials.
Non-limiting examples of magnesium-containing cathode materials include doped manganese oxides, and combinations thereof, and the like, and combinations thereof.
Statement 25. A device according to any one of Statements 18-24, wherein the cathode comprises a conducting carbon material and a cathode material.
Statement 26. A device according to any one of Statements 18-24, wherein the cathode comprises a conversion type material chosen from sulfur, sulfur composite materials, polysulfide materials, air, iodine, metal sulfides, and the like, and combinations thereof.
Statement 27. A device according to any one of Statements 13-26, wherein the device further comprises a liquid electrolyte, which is in contact with the functionalized cross-linked polymer network.
Statement 28. A device according to any one of Statements 18-27, wherein the cathode, anode, and, optionally, a current collector form a cell, and the battery comprises a plurality of the cells and each adjacent pair of the cells is separated by a bipolar plate.

The steps of the methods described in the various examples disclosed herein are sufficient to carry out the methods of the present disclosure. Thus, in an example, a method consists essentially of a combination of the steps of the methods disclosed herein. In another example, a method consists of such steps.

The following examples are presented to illustrate the present disclosure. The examples are not intended to be limiting in any manner.

### Example 1

This example describes functionalized cross-linked polymer networks of the present disclosure. The example also describes methods of making functionalized cross-linked polymer networks and uses thereof.

Designing Polymeric Interphases for Stable Lithium Metal Deposition. In this example, the effect of fluorinated thermosets on the early stages of lithium metal deposition and subsequent growth rate of the deposit front was studied. By tuning the chemistry of the backbone and sidechains of the network, the effect of the physical properties of the polymeric interphase on the morphology of electrodeposited lithium was investigated. Aided by a theoretical linear stability analysis and experimental characterization by techniques that include scanning electron microscopy and operando visualization of the metal deposition, it was found parameters like polymer thickness, metal-polymer interfacial energy and elasticity have a profound effect on the morphology of electrodeposited lithium. Specifically, it was found that an interplay between elasticity and diffusivity leads to a desirable thickness value of the polymeric interphase while higher interfacial energy augment elastic stresses at the metal surface in preventing out of plane growth of the deposited metal. These findings may guide the design of artificial interphases as well as electrolyte components that lead to specific compositions of the SEI.

Design rules for elastic interphases formed on any generic metal anode and utilize experiments based on Li metal anodes to evaluate their effectiveness in arresting the various instabilities (e.g., morphological, chemical, mechanical/orphaning, and hydrodynamic) known to lower lifetime and reversibility of metal anodes, were considered. By combining the experiments with theoretical stability analysis of metal electrodeposition across elastic interphases, it was found that interphase thickness, mechanics, ion transport and interfacial properties all play precise, differentiated roles in setting the optimal interphase design. Thermosetting polymer interphases were focused on because their mechanical and chemical stability can be readily manipulated. A specific goal was to develop design rules that can be implemented without adding substantially to the weight or volume of the metal electrode. Additionally, motivated by a growing body of work showing that fluoride-containing components in liquid electrolytes enhance Li reversibility by regulating the chemistry of the SEI formed on the Li electrode, interphases created using fluorinated polymers that are held together by covalent cross-links were a specific focus. By manipulating the thickness and fluorine content of the polymer layer, the effects of interphase mechanics, ion-transport, and chemistry on nucleation, growth, and reversibility of Li during electrochemical cycling in liquid electrolytes were simultaneously studied.

Fluorinated single-ion conducting polymer coatings for reactive metal anodes based on Lithiated Nafion™ and explored their effectiveness in enhancing Li anode reversibility have been previously reported. A draw-back of such coatings is that because their polymer constituents are held together by physical bonding, they swell significantly in liquid electrolytes that wet the coating, which in turn ensures significant ingress of the liquid electrolyte. The most important consequence is that properties of an arbitrary combination of at least two types of interphases (one explicit, formed by the Lithiated Nafion™ layer and, a second, implicit and formed by electrochemical reduction of the electrolyte solvent and salt) determine the reversibility of the Li anode. This obviously compromises fundamental studies, which impedes development of broadly relevant design rules for such interphases.

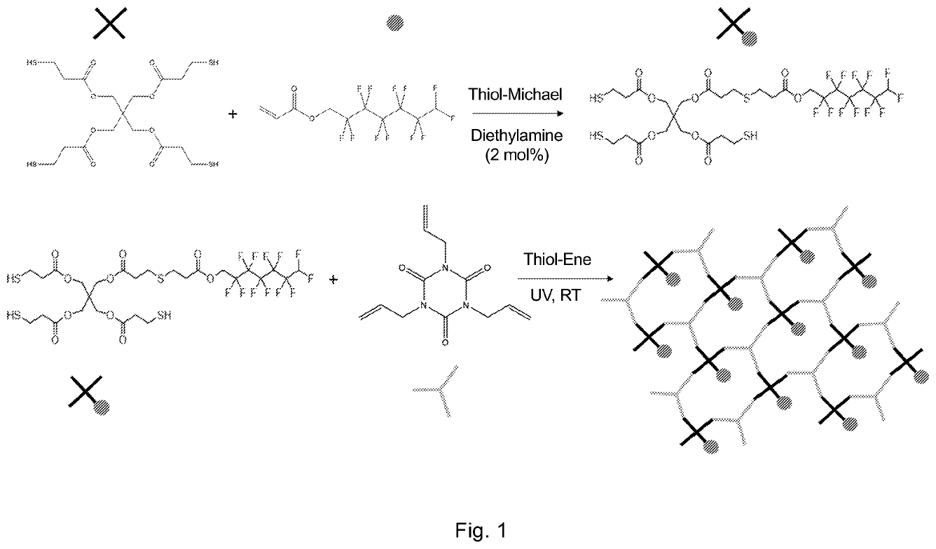

In this example, Thiol-Michael and Thiol-ene reactions were used to create fluorinated polymer coatings via a two-step process (FIG. 1). In the first step, a methacrylate terminated fluoroalkyl monomer was added to Pentaerythritol tetrakis(3-mercaptopropionate) in the presence of a nucleophilic catalyst (Diethylamine). The methacrylate end reacts with the thiol group through a Thiol-Michael addition to form cross-linkers containing fluorinated side chains with fluorination levels set by the molecular weight and fluorine content of the fluoroalkyl monomer. In the second step, the functionalized cross-linkers were photopolymerized in the presence of the tri-functional (1,3,5-Triallyl-1,3,5-triazine-2,4,6(1H,3H,5H)-trione-3E) via the Thiol-ene reaction. By maintaining a 1:1 molar ratio 10 between the fluoroalkyl monomer and mercaptopropionate, a statistical distribution of mono, di and tri and tetra-functional thiol crosslinkers were obtained. Here, only the average product were considered to be a trifunctional crosslinker (3TF). Additionally, by tuning the length of the fluorinated sidechains, it is possible to create cross-linkers with varying degree of fluorination, designated here as 3T3F, 3T7F and 3T10F.

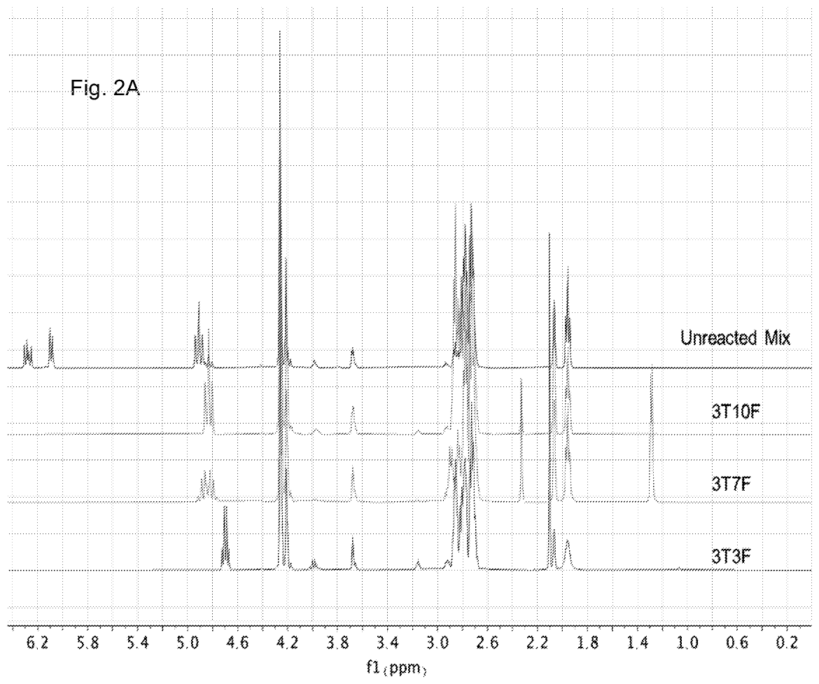

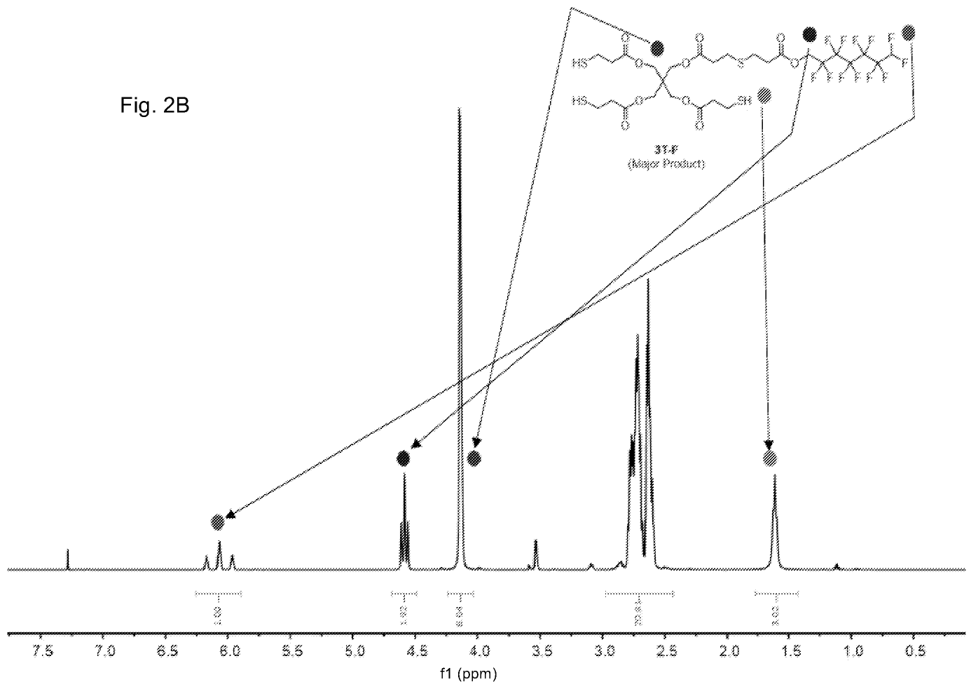

NMR (FIG. 2) was used to analyze the synthesis product and to quantify the fluorination level achieved in the materials. The disappearance of vinylic peaks near 6 ppm in the unreacted mixture confirmed the completion of reaction between the thiol and acrylate groups. The monomers along with the photoinitiator were dissolved in a solvent mixture (Chloroform and Ethanol, 1:1 volume ratio) and spin coated on polished stainless-steel 20 substrates before UV-Curing to obtain coatings of different thicknesses. The tuning of different parameters like concentration of monomers and RPM to control the thickness values are shown in Table 1. Four thickness (0.2, 2, 10 and 100 um) were chosen for the initial study and the crosslinker used was 3T10F (highest fluorine content). The cured coatings were characterized by FT-IR to confirm the disappearance of S—H and C═C peaks at ˜0.2500 cm⁻¹ and 1650 cm⁻¹.

TABLE 1
Optimization of spincoating conditions for
different thicknesses of crosslinked films

| Concentration(g/ml) | RPM(/s) | Thickness(microns) | Stdev |
|---|---|---|---|
| 0.2 | 100 | 14.1 | 3.2 |
| 0.2 | 500 | 2.2 | 0.91 |
| 0.2 | 2000 | 0.7 | 0.19 |
| 0.2 | 10000 | 0.2 | 0.08 |
| 1 | 500 | 98 | 2 |
| 1 | 2000 | 10.3 | 1.24 |
| 1 | 6000 | 5.6 | 1.26 |
| 1 | 10000 | 2.7 | 0.38 |

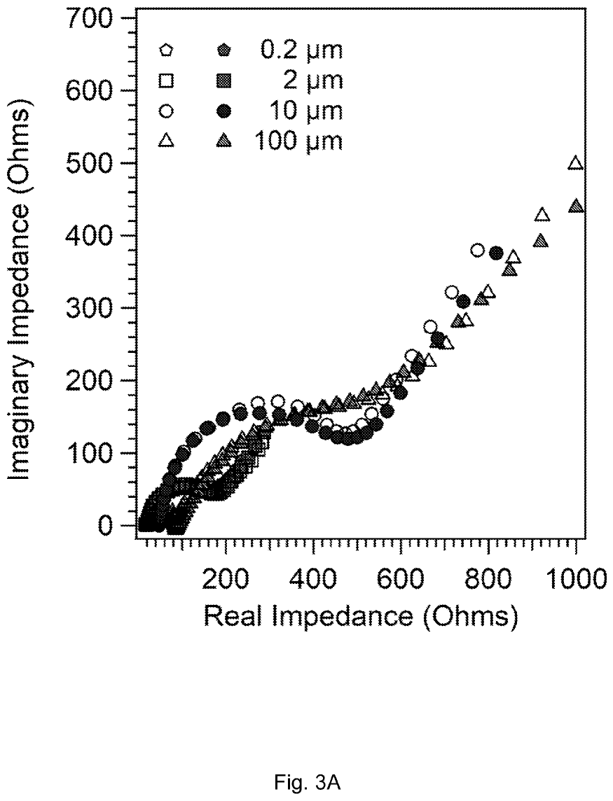

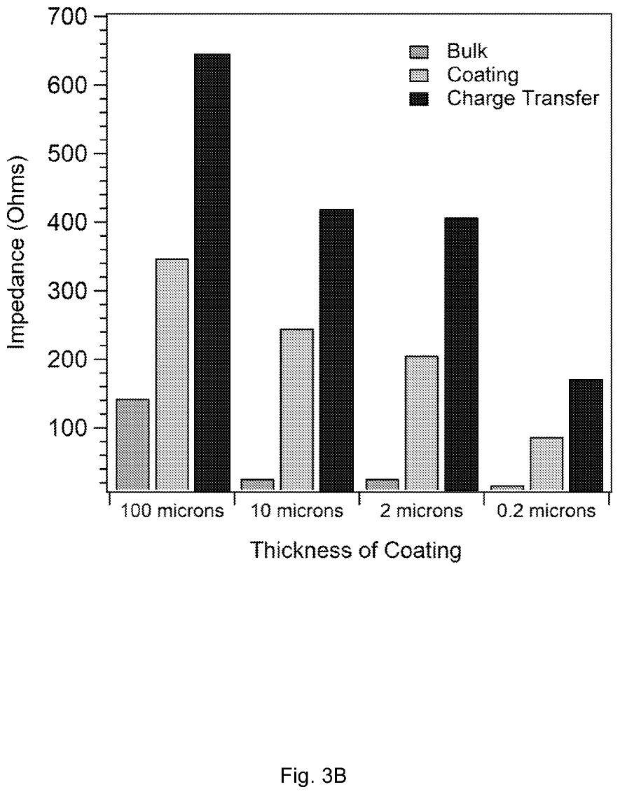

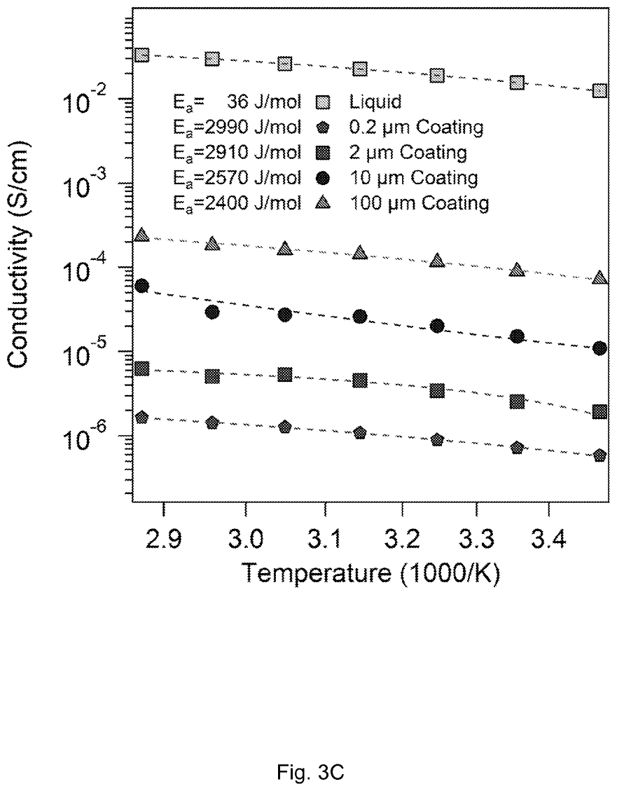

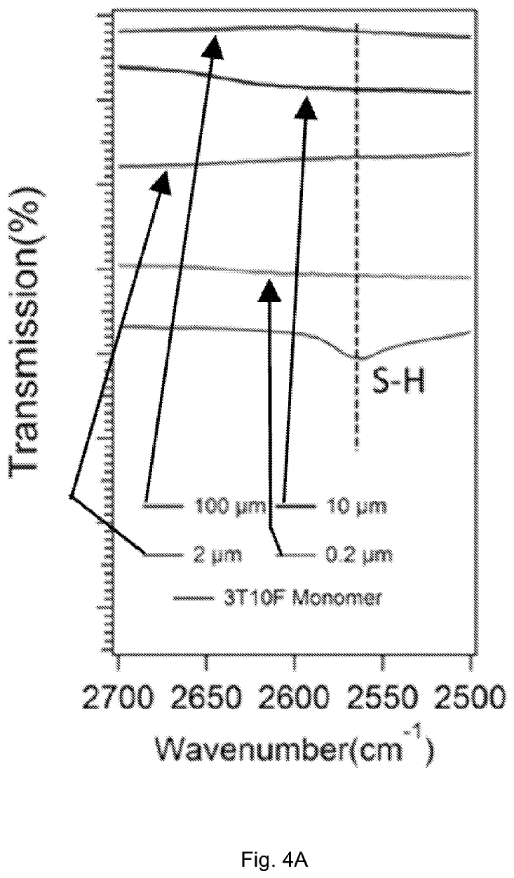

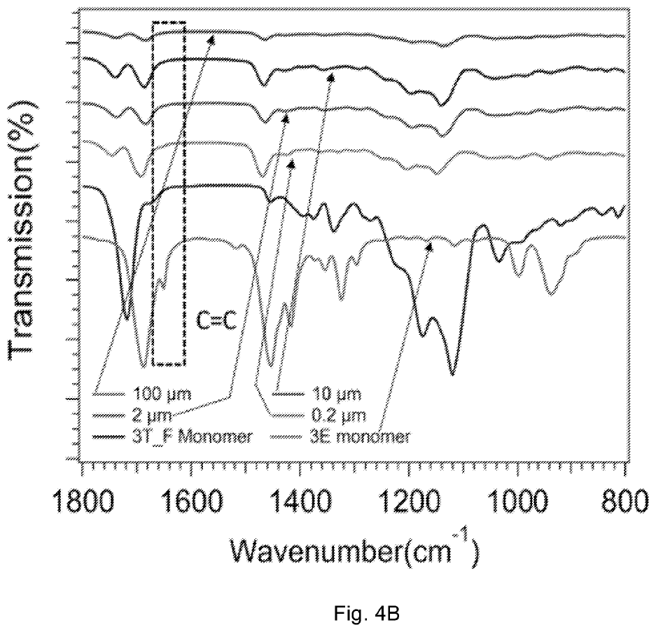

The effect of coating thickness on ion-transport properties at the electrode/electrolyte interface using impedance spectroscopy measurements performed for the different systems was evaluated, first at room temperature (FIG. 3A). The cells used for the measurements were composed of the coated polished stainless-steel electrode and an 0-ring filled with a liquid electrolyte (1M LiPF₆ in EC/DMC) in the bulk. By fitting the spectra with an appropriate model (FIG. 4), the individual bulk, coating and charge transfer resistances was extracted (FIG. 3B). It is clear that most of the effect of the thickness is restricted to the coating and charge transfer resistances; although at the highest thickness value the bulk resistance also seems to increase, possibly due to the fact that the coating thickness and the inter electrode spacing almost the same order of magnitude. By performing temperature dependent measurements and fitting the data to the Vogel-Tamman-Fulcher model for ion transport, the activation energy for motion within the polymeric coating phase as well as the bulk phase can be obtained (FIG. 3C). The results indicate that the activation energy for ion transport within the coating is almost two orders of magnitude higher than that of bulk liquid electrolyte phase, consistent with expectations and previous results.

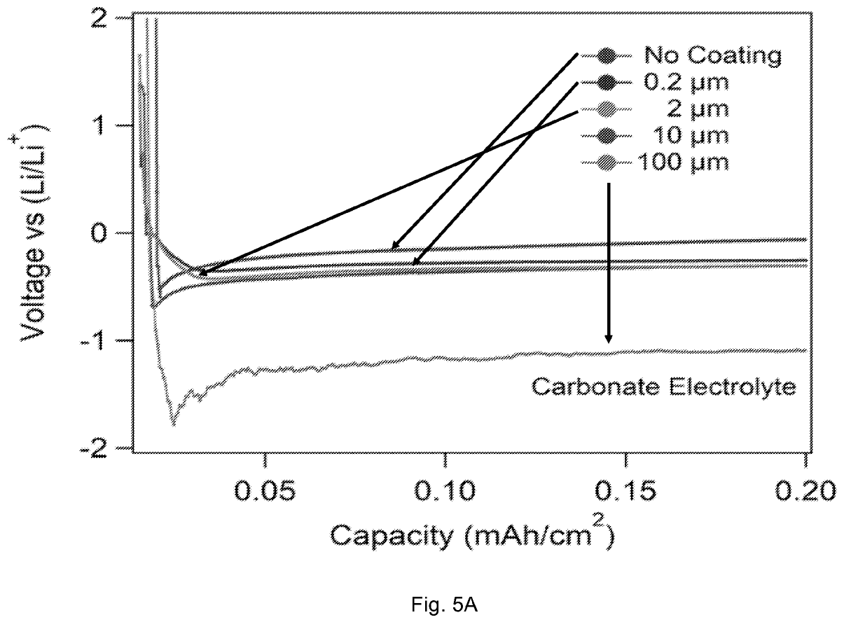

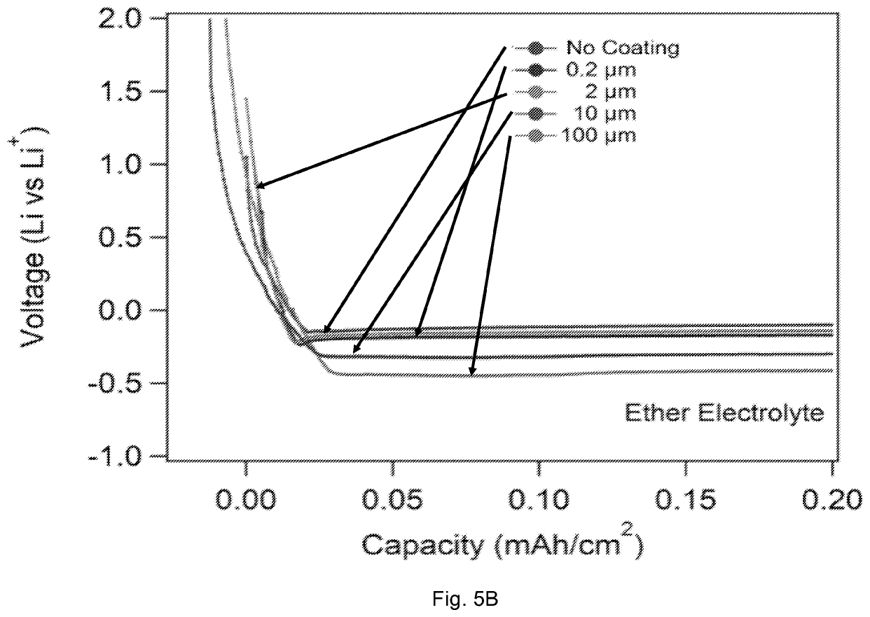

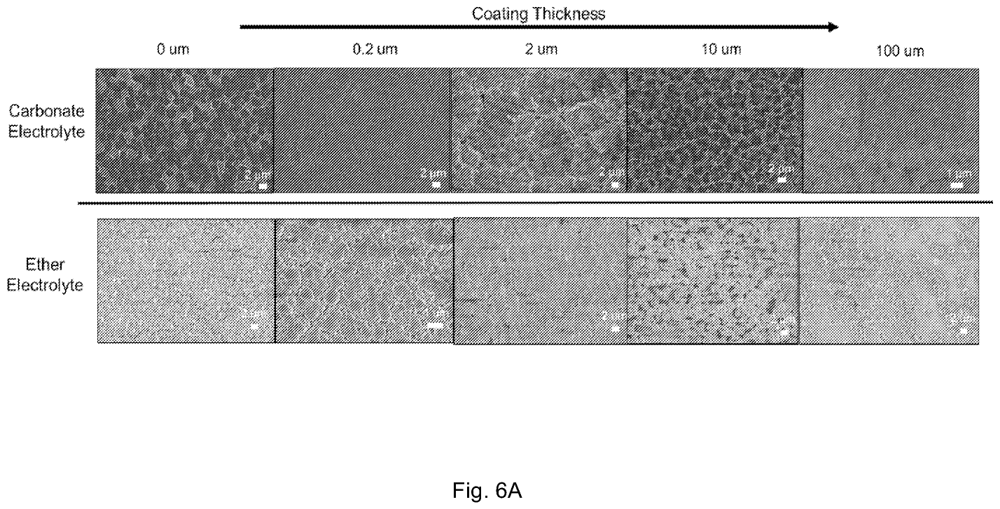

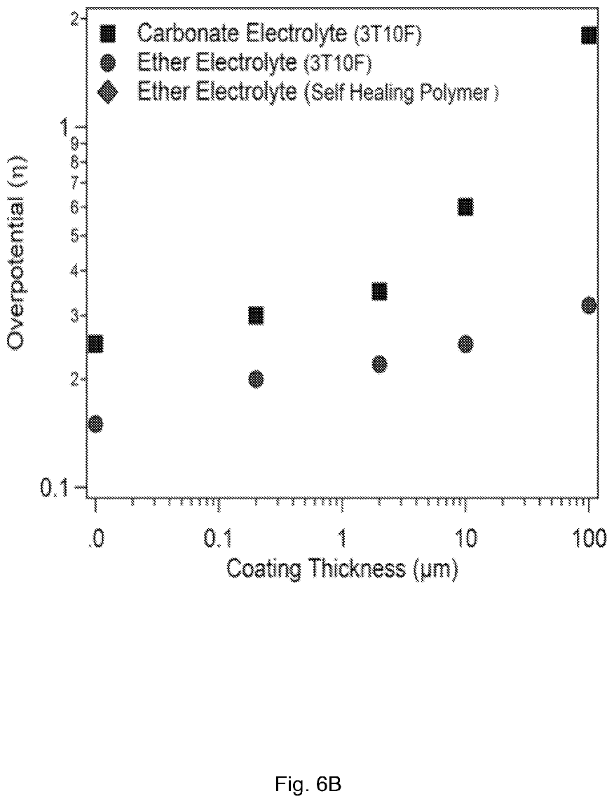

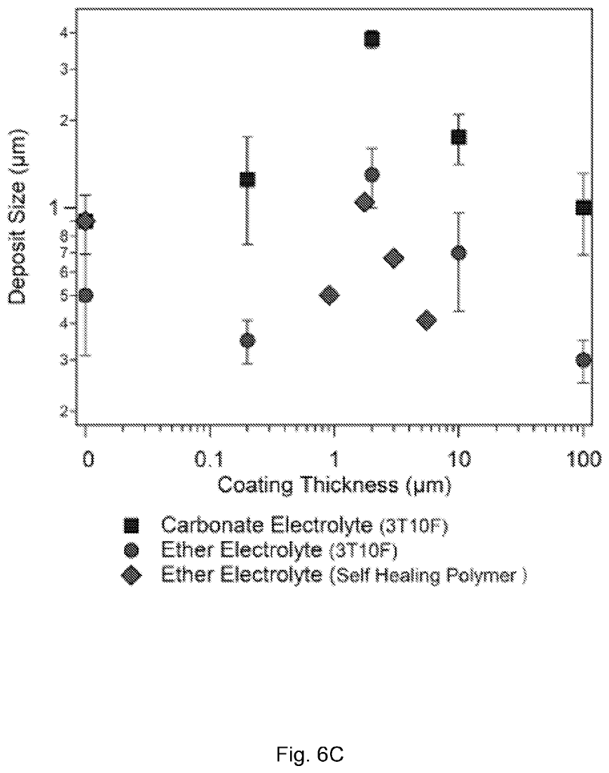

The effect of coating thickness on the early stage deposition and growth of Li deposits provide complimentary information about how the coating physical and mechanical properties influence Li nucleation and growth. For this purpose, a small amount of lithium (0.1 mAh/cm²) was deposited under galvanostatic conditions (J=1 mA/cm²) on the fluoro-polymer-coated substrates in two classes of electrolyte: (i) an ether based (1M LiTFSI in Diglyme) and (ii) a carbonate based (1M LiPF₆ in EC/DMC) electrolyte. The nucleation overpotential, which is the first peak observed in the voltage response (FIG. 5), measured at a fixed current density increased with increasing thickness of the coating for both electrolytes as shown in FIG. 6B. This observation is consistent with expectations based on the impedance results, whereby the barrier to overcome for nucleating lithium deposits scales with interfacial and charge transfer resistances. Scanning Electron Microscopy (SEM) was used to image the electrodes immediately after the end of the nucleation phase to analyze the lithium nuclei size distribution (FIG. 6A).

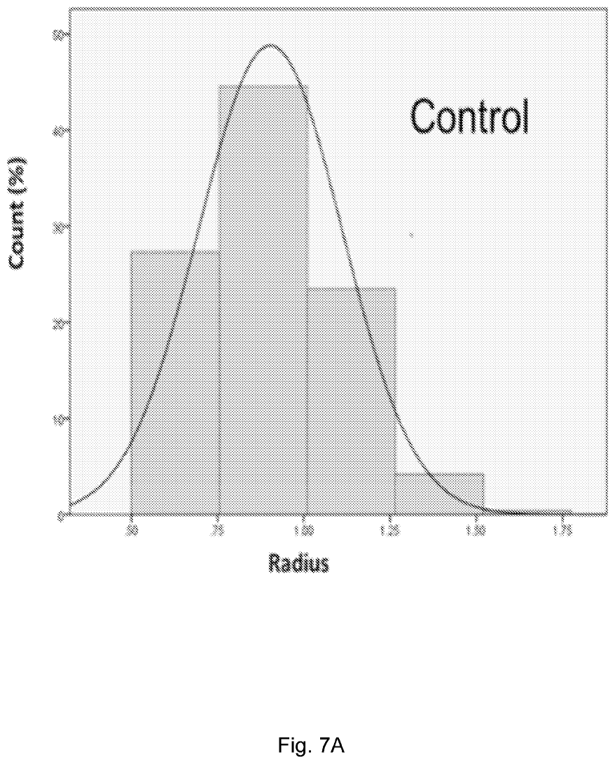

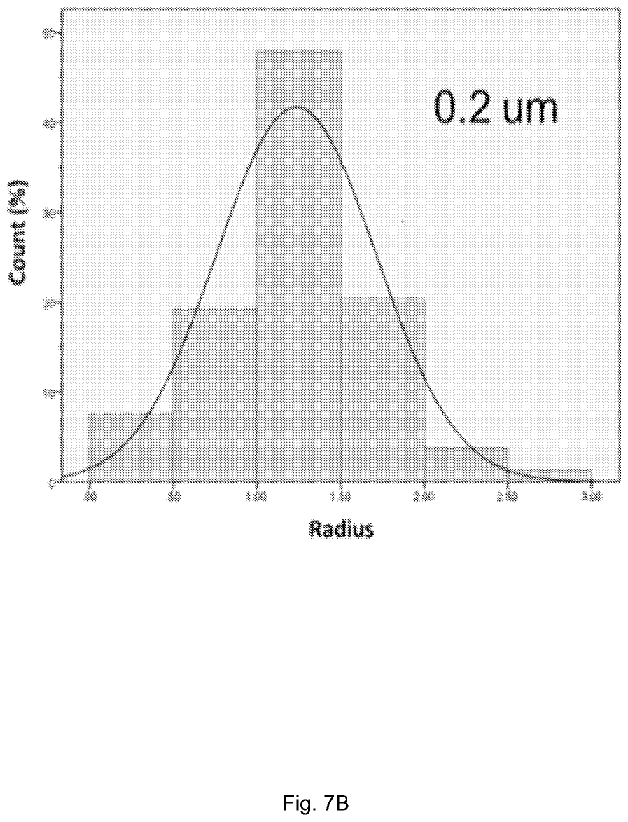

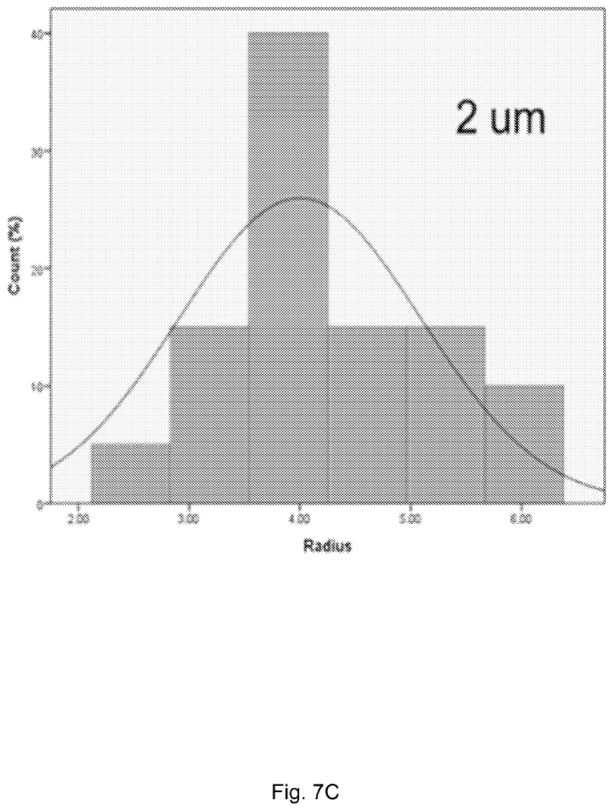

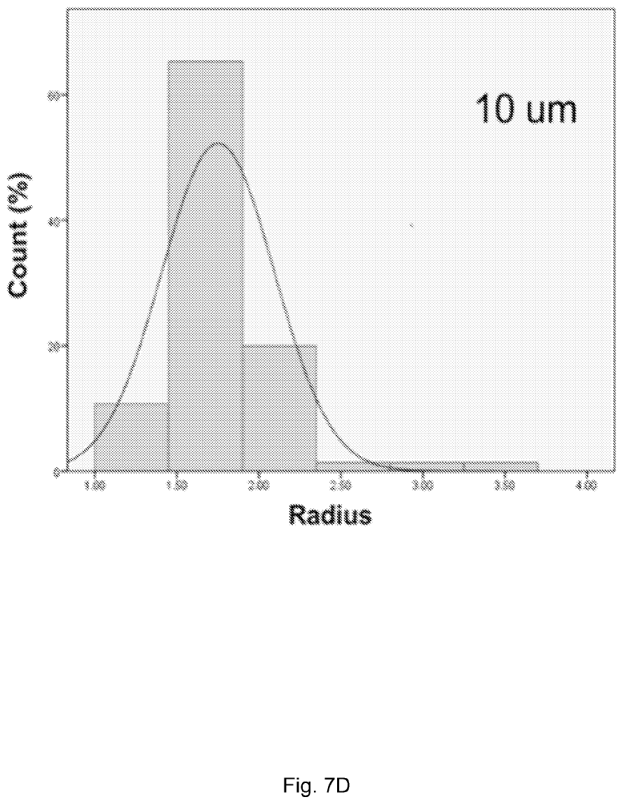

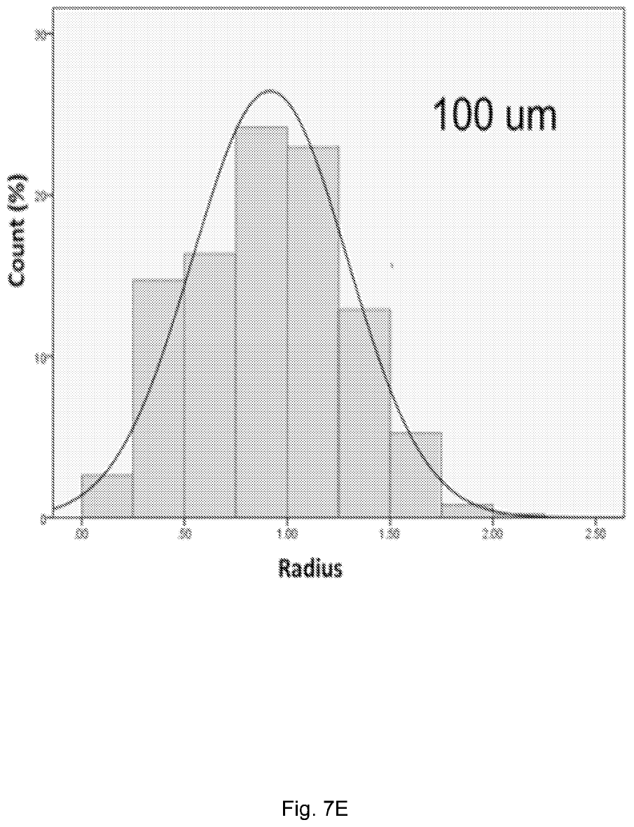

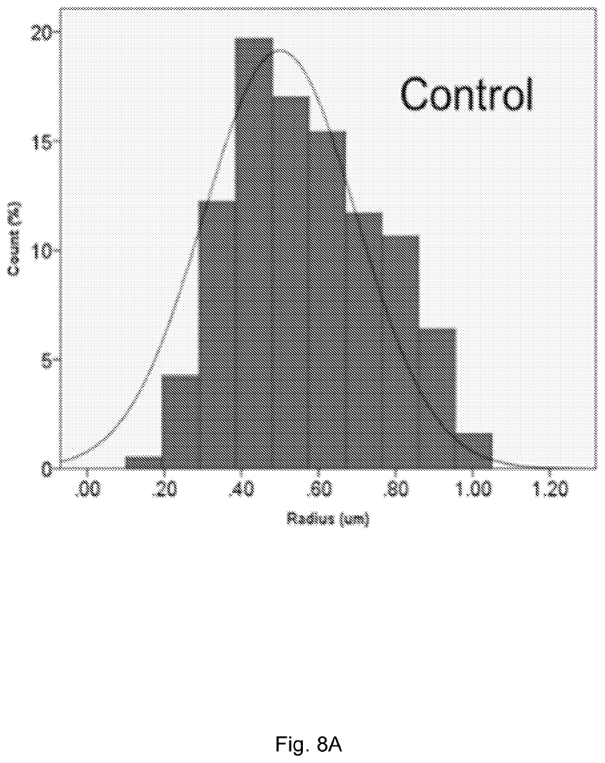

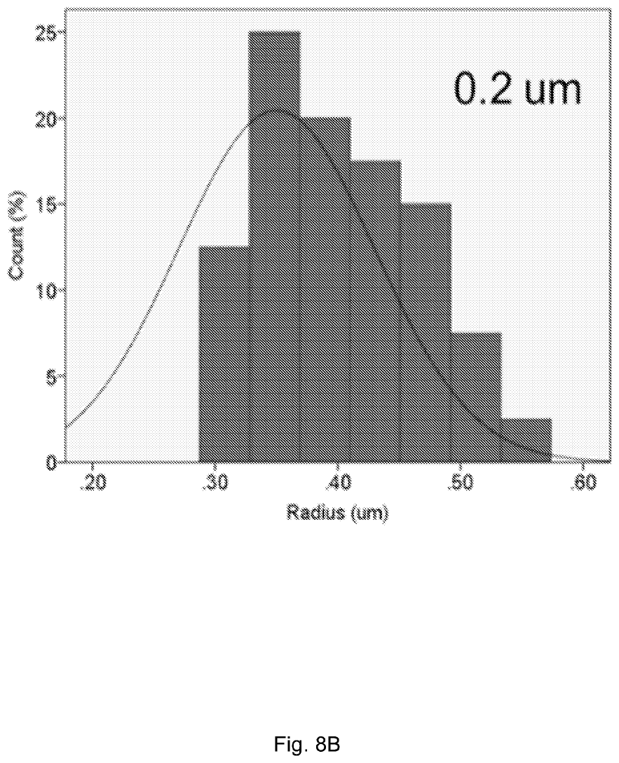

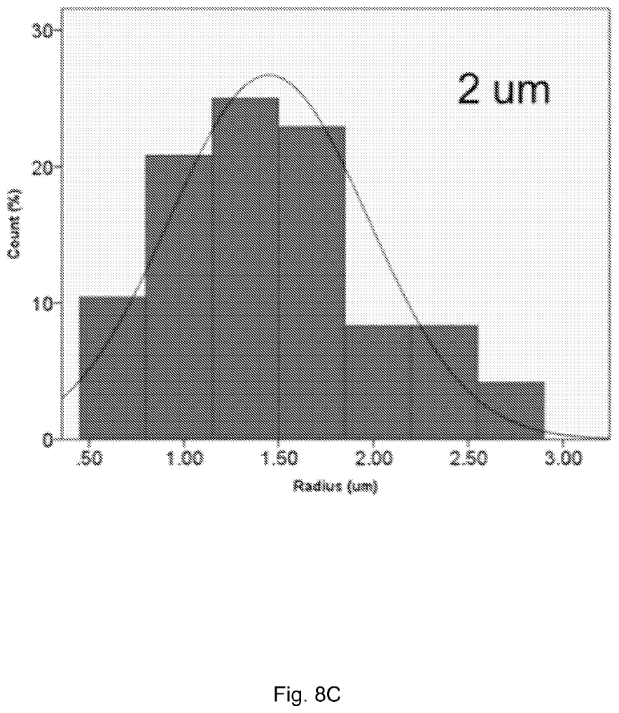

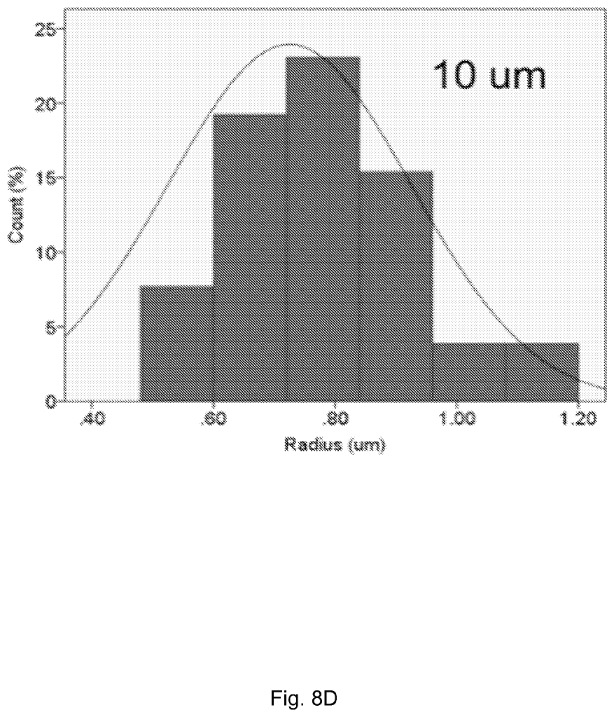

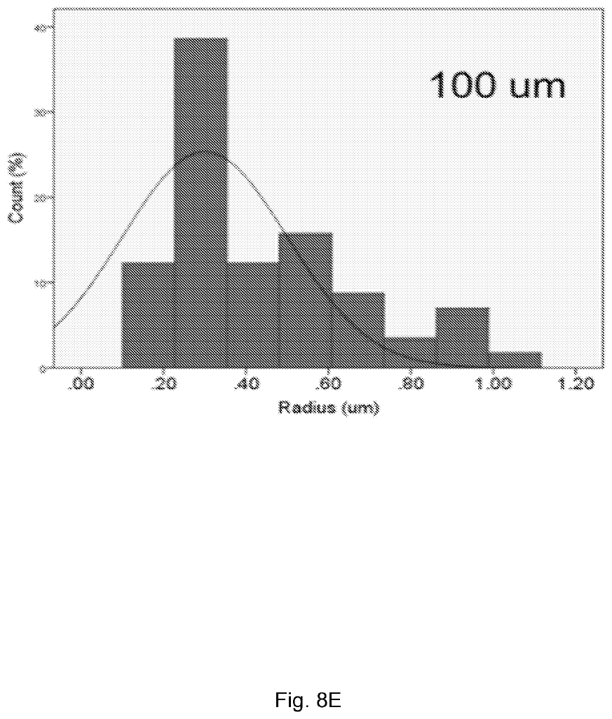

As shown in FIG. 6A, there is a significant difference in the lithium morphology under the influence of the coating. The nuclei are smaller, irregular and more three dimensional in nature in the bare electrolyte case and under the influence of the coating, they are generally larger, flatter, and more two-dimensional for both electrolytes, which is the expected qualitative result if coating mechanics are assumed to limit out-of-plane growth. Flatter and bigger metal electrodeposit nuclei have been reported to be beneficial for long-term operation and stability as these would grow into more planar deposits as compared to smaller nuclei. A more in-depth analysis of the SEM images provides additional information about how the nuclei size and size distribution varies with coating thicknesses. Results depicted in FIGS. 7 and 8 show that the size distribution can be crudely fit to a normal distribution, indicating that while a large population of nuclei form at a certain time, a smaller population of nuclei may be developing at later times and growing independently during early stages of deposition, consistent with previous reports. Surprisingly, the average nuclei diameter (FIG. 6C) is observed to be a decidedly non-monotonic function of coating thickness, with the largest nuclei observed at an optimal coating thickness of approximately 2 μm, irrespective of the electrolyte used in the bulk phase. While prior studies of polymer thin film mechanics have shown that mechanical strength rises with film thickness for nanometer-thick coatings, the large μm-scale thicknesses at which the optimum was observed implies at mechanics alone cannot be the source of the behavior. FIG. 6C also includes a data set from Lopez, J. et al. (Effects of Polymer Coatings on Electrodeposited Lithium Metal, J. Am. Chem. Soc. 140, 11735-11744 (2018)) that reports the effect of a Self-Healing Polymer on the average deposit size. Although the systems vary to a considerable extent (for example, use of a separator in the latter and a DOL/DME based electrolyte as opposed to Diglyme used in this study), the general observation for existence of an optimum thickness continues to hold in the cases studied.

In order to understand the source of the maximum and how the numerous design variables—mechanics, thickness, ion-transport characteristics, and interfacial properties—available to the materials scientist might be used to create optimal interphases for any metal anode, linear stability analysis was performed for Li electrodeposition under an elastic interphase layer. The analysis is presented in detail as supplementary material in Section I below. The methodology is similar to that reported a previous study of Li electrodeposition in structured solid-state, bulk electrolytes.

Briefly, in the linear stability analysis how the growth rate o of perturbations of prescribed wave length (λ≡λ/k) or, equivalently wave number k, is influenced by changes to the coating thickness, h; shear modulus, G^{s}; cation diffusivity, D_{c}ⁱ; salt concentration, C_{c0}, at the metal in the unperturbed state; current density J, and interfacial energy y was investigated. For simplicity, the coatings were modeled as simple Hookean elastic solids with Poisson ratio v^{m} and consider the coating to be in equilibrium with a bulk liquid electrolyte with cation diffusivity, D_{c}^{o}=D_{c}ⁱ/D, and a solid metal with molar volume vₘ. Here D is termed the diffusivity ratio and measures the relative rates at which cations diffuse in the electrolyte bulk and in the coating; for the case of a liquid electrolyte bulk and solid-state polymer interphase considered in the present study a reasonable assumption would be, D<<1. Equations S-1:S-4, in conjunction with flux balance equations, subject to the boundary conditions S-5:S-7, were solved to determine how small-amplitude perturbations of the Li electrode thickness shrink (σ<0) or grow (σ>0).

When the wave number of electrode perturbations is much shorter than the interphase layer thickness, i.e., kh>>1, the following analytical formula predicts how the growth rate is affected by the interphase properties and cell operating conditions,

$$σ = \frac{{v}_{m}}{F} [ kJ - A ( γ {k}^{3} + 2 {G}^{s} {k}^{2} ) ] .$$

Here

$$A = \frac{{D}_{c}^{i} {v}_{m} {FC}_{c 0}}{RT} \frac{2}{3} ( 1 + {v}^{m} ) ,$$

and R, T and F are the gas constant, temperature and Faraday's constant respectively. In this limit, elastic stresses generated in the polymer coating decay completely over the thickness of the interfacial layer and the coating-outer liquid electrolyte-interface is undisturbed. The modulus of the polymer layer augments the surface tension contribution (k³γ) in stabilizing (making u more negative) the deposition, but the effect is implicitly dependent on the polymer layer thickness through C_{c0}. The growth rate has a maximum at a wavenumber

$${k}_{max} = \sqrt{{( \frac{2}{3} \frac{{G}^{s}}{γ} )}^{2} + \frac{J}{3 A γ}} - \frac{2}{3} \frac{{G}^{s}}{γ} ,$$

which sets the half-wavelength, λ*≡π/kₘₐₓ, of the fastest growing mode. Thus, a larger interphase modulus and/or lower current density, lowers kₘₐₓ, which would favour deposition of larger electrodeposit structures. Likewise, it was observed that for a given polymer coating material and outer electrolyte chemistry (i.e. fixed Gₛ and γ), deposition current density, and in a situation when the polymer layer has a lower cationic diffusivity than the outer liquid electrolyte (i.e. D<1), increasing the interphase layer thickness lowers the diffusion-limited current density,

$${J}^{*} = {\frac{4 {D}_{c}^{o} {FLC}_{0}}{{( L - h )}^{2}} [ \frac{h ( 2 L - h ) {D}_{c}^{o}}{{( L - h )}^{2} {D}_{c}^{i}} + 1 ]}^{- 1} ,$$

which lowers C_{c0} and, consequently, A; reducing the size of the fastest growing mode.

In comparison, when the interfacial film is much thinner than the wavelength of the electrode perturbation, i.e. kh<<1, the perturbation growth rate has a more complicated form,

$$σ = \frac{{v}_{m}}{F} [ kJ \frac{D ( 1 + kh )}{D + kh} - \frac{{D}_{c}^{i} {v}_{m} {FC}_{c 0}}{RT} \frac{2}{3} ( 1 + {v}^{m} ) \frac{1 + khD}{D + kh} ( γ {k}^{3} + \frac{{G}^{s}}{1 - {v}^{s}} {h}^{3} {k}^{5} ) ] .$$

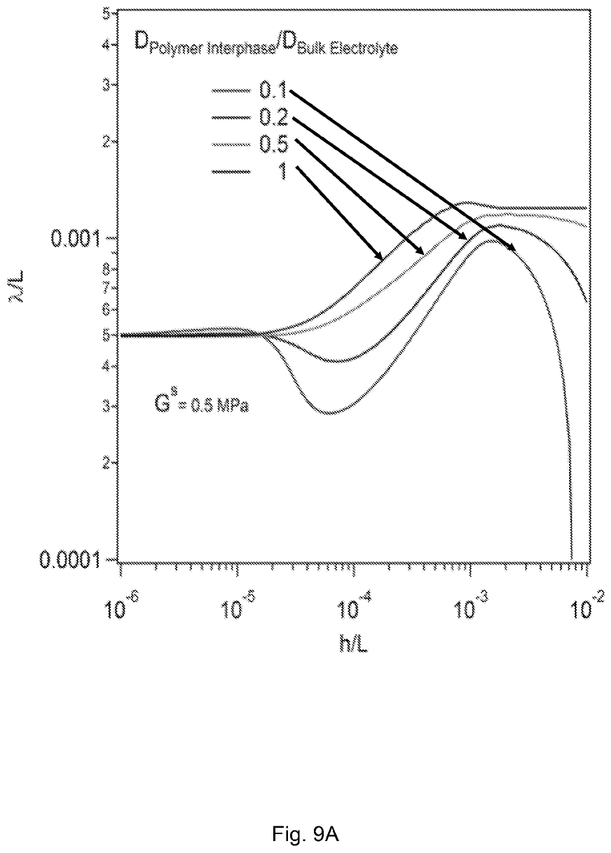

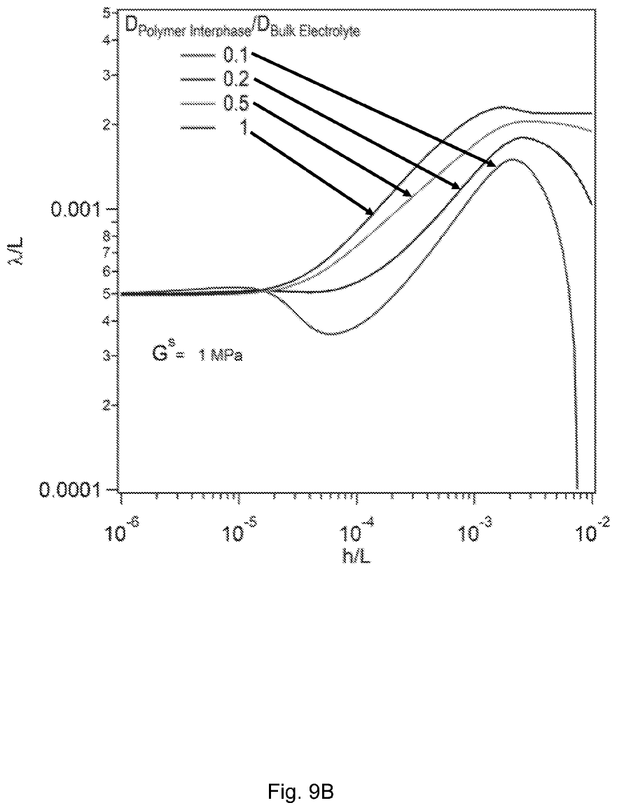

Here the deformation of the film-liquid interface follows that of the metal-film interface. The effect of the coating thickness on the half-wavelength of the fastest growing perturbation is plotted in FIG. 9A-9B. The sizes of the deposits are evidently influenced by the elasticity of the polymer layer only if the layer is thicker than h≳(γ²D_{c}ⁱvₘFC₀)^{1/3}/(JG^{S}RT)^{1/3}. For coatings thinner than this limit, the primary mechanism for stabilizing the deposition is the interfacial energy of the metal-polymer interface, and the preferred wavelength is unaffected by the coating thickness. As the coating becomes thicker, its elasticity starts to contribute more appreciably in stabilizing the deposition with the effect being highly nonlinear in thickness. For very thick coatings, the elastic stresses completely decay over the film as discussed before and increasing the thickness further only adversely affects the stability of deposition due to higher resistance of the film. This trade-off is particularly noticeable as the diffusivity contrast between the coating and liquid increases and qualitatively explains the maximum in deposit size apparent in all of the experimental results shown in FIG. 6C.

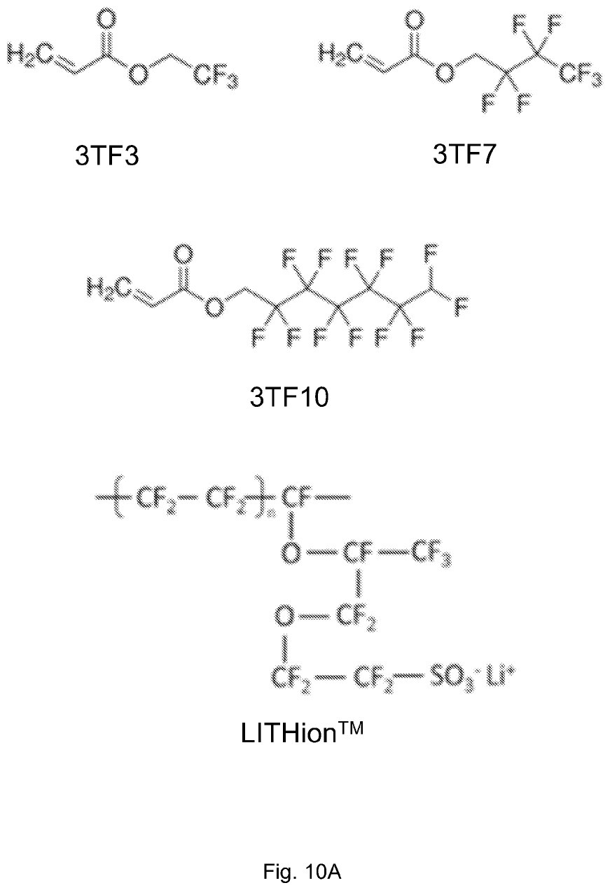

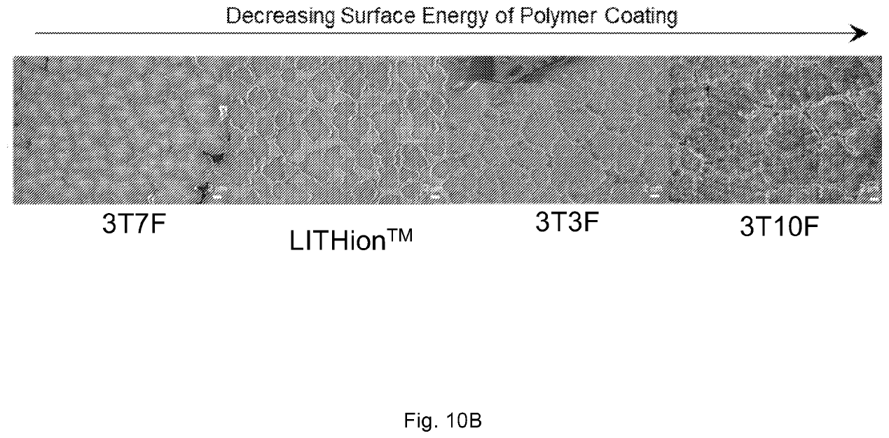

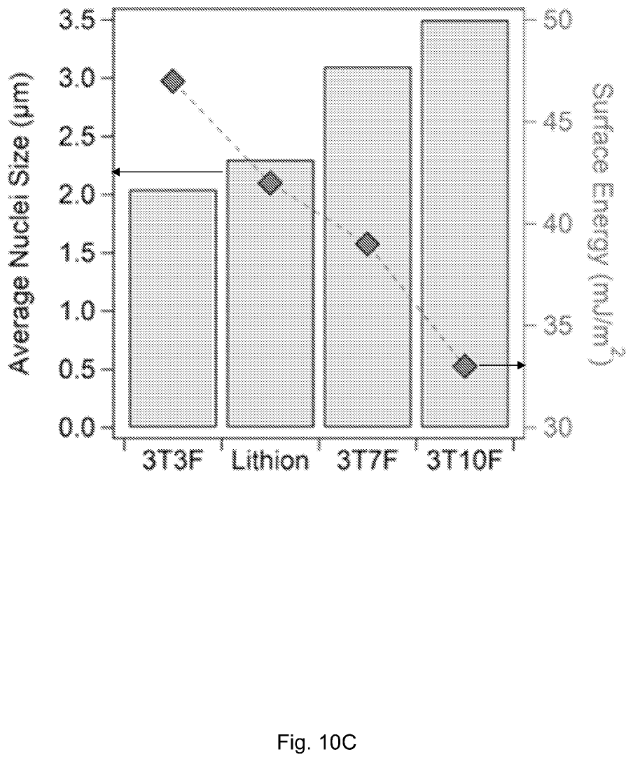

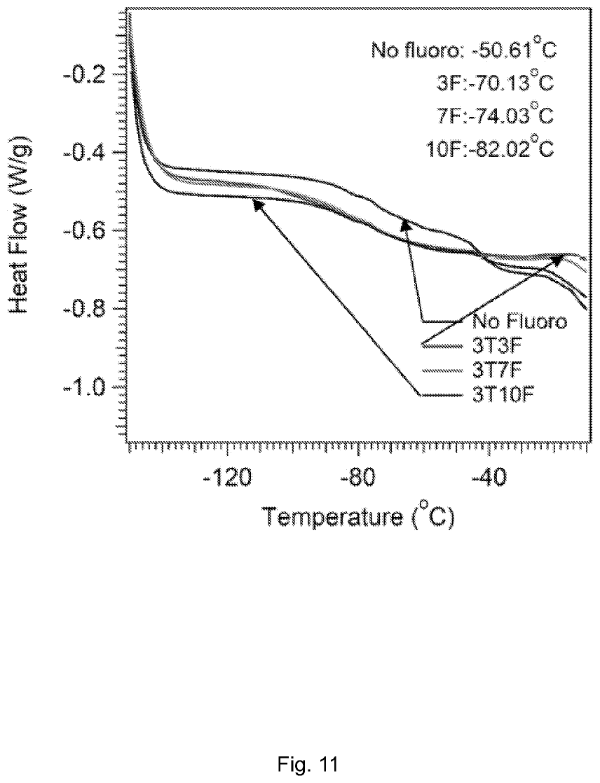

The maximum coating thickness for which interfacial energy alone stabilizes the metal deposition process [h≤(γ²D_{c}ⁱvₘFC₀)^{1/3}/(JG^{s}RT)^{1/3}], is found to be ˜150 nm for the conditions used in our experiments. Thus for the thicknesses of the interphase layers used in the study, both surface tension at the metal-polymer interface and elasticity are expected to play appreciable roles in the electrodeposit growth and stability. These two factors and their effect on lithium deposition, beginning with interfacial energy were attempted to be understood and studied. The effect of surface energy of different polymeric systems with different chemistries were previously studied and concluded that lower surface energy polymers yield more stable deposits. Lower surface energy essentially results in high interfacial energy at the metal-polymer interface, which has a stabilizing effect. In order to systematically study this effect, four polymer coatings with varying degree of fluorination to alter the surface energy were created. The length of the fluorinated side chains in the first step was modified to yield monomers with different extents of fluorination before crosslinking. This approach attempts to keep physical properties of the networks apart from degree of fluorination constant. The functionalized thiol monomers 3T3F, 3T7F and 3T10F are shown in FIG. 10A. The crosslinked systems were characterized using Differential Scanning Calorimetry as shown in in FIG. 11 The glass transition temperatures were found to decrease with increasing length of fluorine side-chain, possibly due to increase in free volume within the formed network. Lithiated Nafion was also included as a fourth polymer for comparison. Surface energy was calculated using contact angle measurements and Owens-Wendt method. FIG. 10B shows SEM images of lithium deposits under the influence of different coatings (0.1 mAh/cm² @ 1 mA/cm² with Carbonate Electrolyte in Bulk phase). It is clear that the deposit size is correlated with the fluorine content of the polymer to a certain extent, consistent with previous reports. The morphologies of the deposited lithium however were consistently different under the influence of the coatings as compared to without a coating, indicating that elasticity plays a big role in enabling flatter deposits and preventing out of plane growth. The measured surface energies were compared with the extracted nuclei sizes for the different systems, as shown in FIG. 10C. Lower surface energies were conclusively found to result in larger lithium deposit sizes.

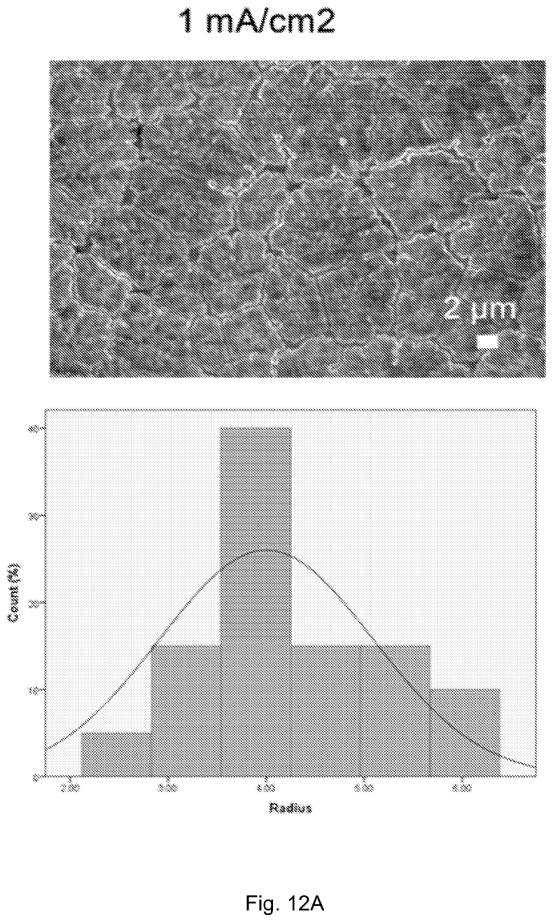

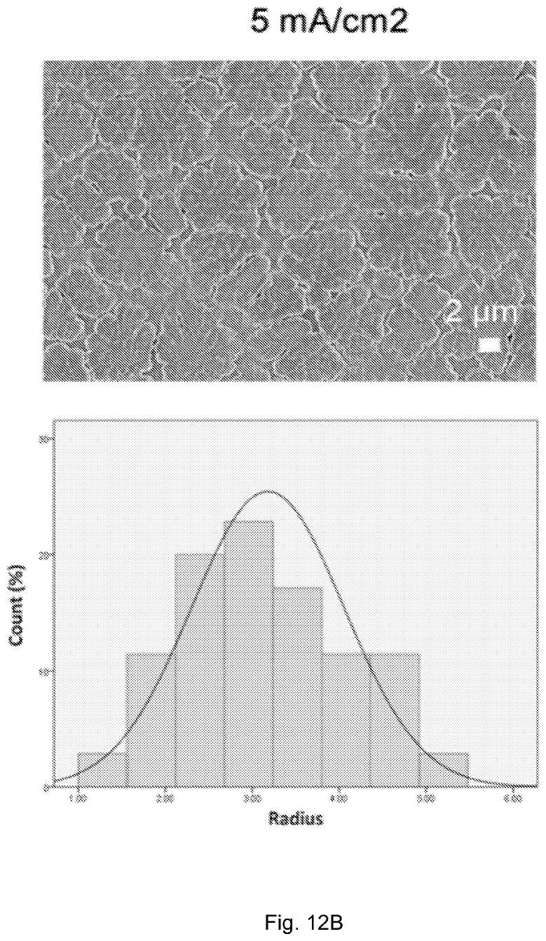

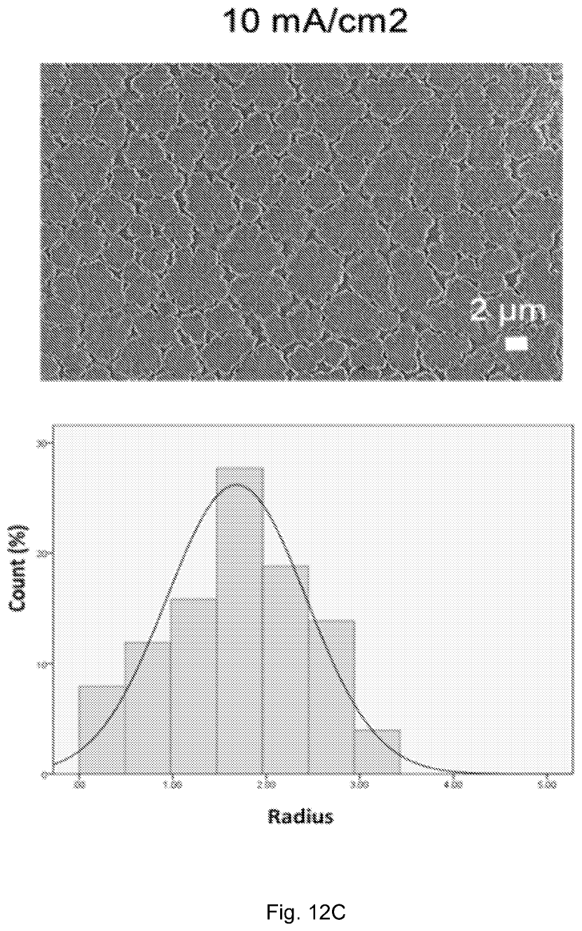

The effect of current density on the radius of the lithium nuclei has been previously reported in detail for liquid electrolytes with and without additives. Lithium metal deposited under the influence of the optimized thickness of the fluorinated polymer coating at different current densities was investigated and the SEM images are shown in FIG. 12. The nuclei sizes decreased with increasing current density, consistent with previous observations and results. It is also apparent that the nuclei density increases with increasing current density, with the distribution crudely fitting to a gaussian curve, indicating that the fluorinated polymeric interphase has a similar influence on the growth dynamics of the lithium nuclei compared to an in-situ formed fluorinated interphase from additives like Fluoroethylene Carbonate (FEC).

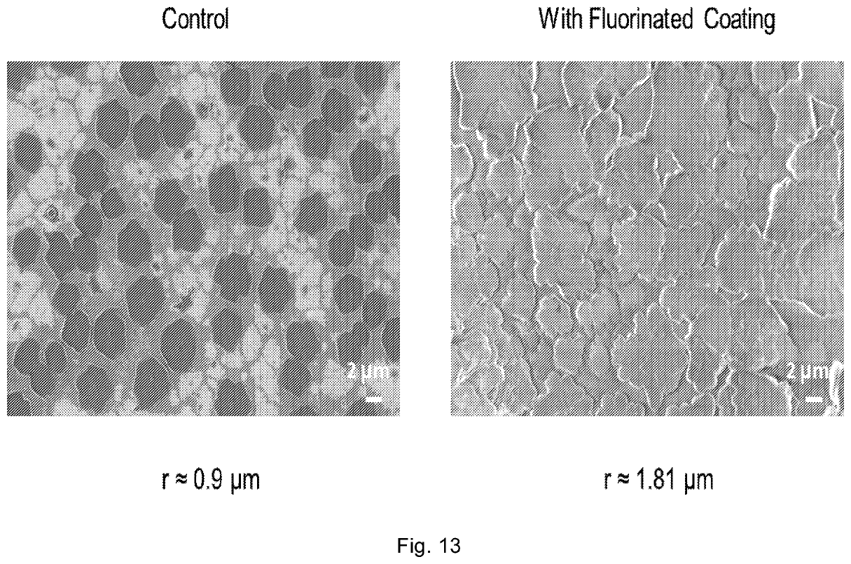

In order to evaluate the utility of the fluorinated coating in influencing the morphology at early stages, galvanostatic deposition in the presence and absence of the polymer coatings on polished stainless-steel substrates was carried out for sodium metal, where the formation of fragile dendritic structures is seen as a more severe problem than that in lithium metal. The SEM images captured after the nucleation phase is shown in FIG. 13. Electrolyte used is 1M NaPF₆ in EC/DMC

The deposit formed under the influence of the fluorinated coating is higher in density and radius as compared to that of the no coating case, where sparse and small deposits are present.

The morphology of the electrodeposits is quite different in both cases. Specifically, when the interphase is formed spontaneously (i.e. no polymer coating is applied) Li is seen to form more three-dimensional nuclei as compared to the planar structures formed under the coatings. This further confirms the universal nature of fluorinated polymeric interphases in enabling planar deposits at the early stages of metal deposition.

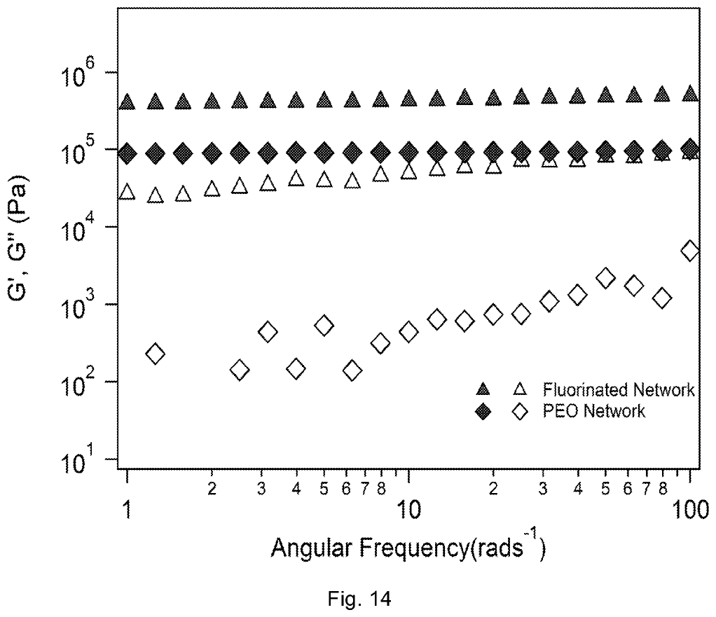

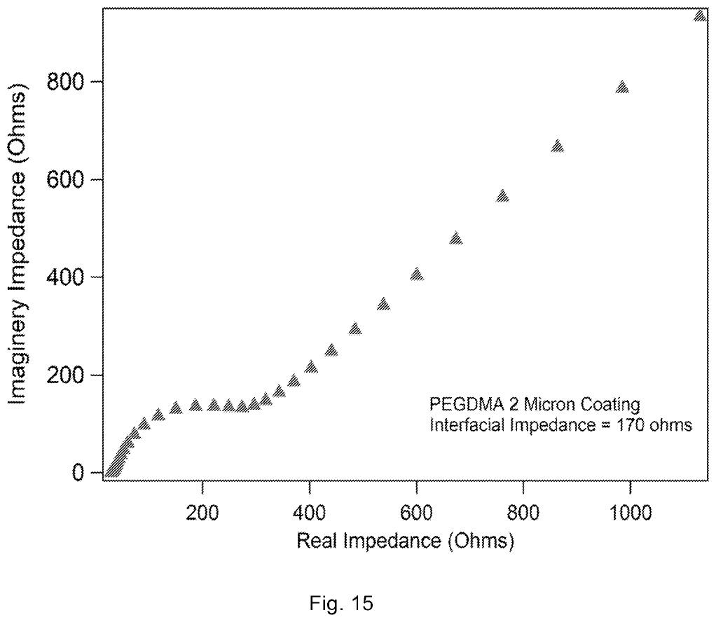

Having understood the effect of coating thickness and surface energy on the size and distribution of lithium deposits at early stages, the impact of the polymer inerphases on Li deposition at higher capacities (i.e. in the “growth regime”) was evaluated. The results in FIGS. 6A-6C illustrated that for a constant thickness of the coating, assuming no change in resistance, diffusivity and other physical properties, elasticity has an important effect in growth rate of lithium deposits. To look at how the growth rate of lithium deposition is affected by the elasticity of the interfacial layer, an ether based cross-linked polymer based on PEGDMA (M_{w}=450 g/mol) network with a lower shear modulus (FIG. 14) value than the fluorinated network was included in the study for a complete comparison. The resistance of the ether-based coating (2 μm) was evaluated using the same protocol as reported for FIG. 3A and the impedance spectrum is shown in FIG. 15. It is evident that the coating resistance value is roughly the same as the fluorinated polymeric interphase, eliminating any difference in interfacial conductivity between the two systems that could influence the transport of ions and deposition of lithium metal. The coating thickness was maintained as 2 μm in all cases and Table 2 shows the physical properties of the coatings.

TABLE 2
Interfacial Layer Properties for coated and bare electrodes

| | Surface | Surface | | |
|---|---|---|---|---|
| | Energy of | Energy of | Modulus | Height |
| | Lithium (J/m2) | polymer | (MPa) | (um) |
| Lthium/3T10F | 0.52 | 0.033 | 0.497 | 2 |
| Lithium/PEGDMA | 0.52 | 0.045 | 0.101 | 2 |
| Lithium/Bare | 0.52 | — | — | — |
| Electrolyte | | | | |

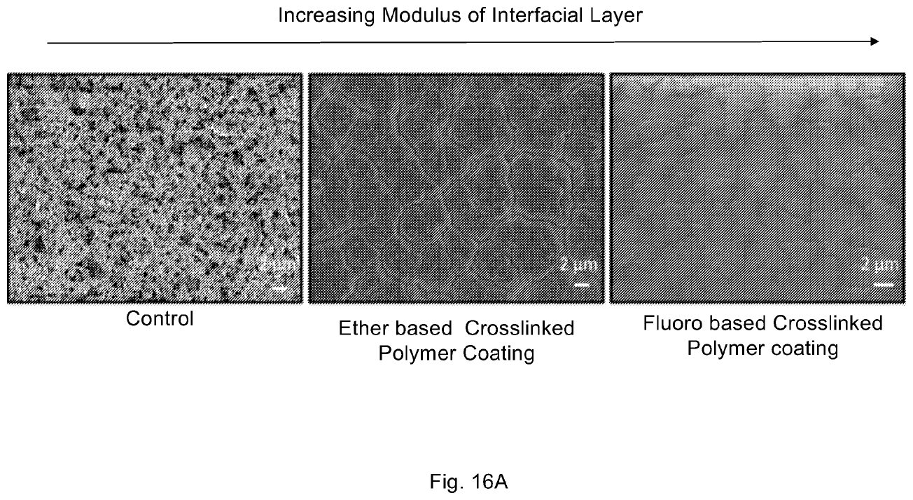

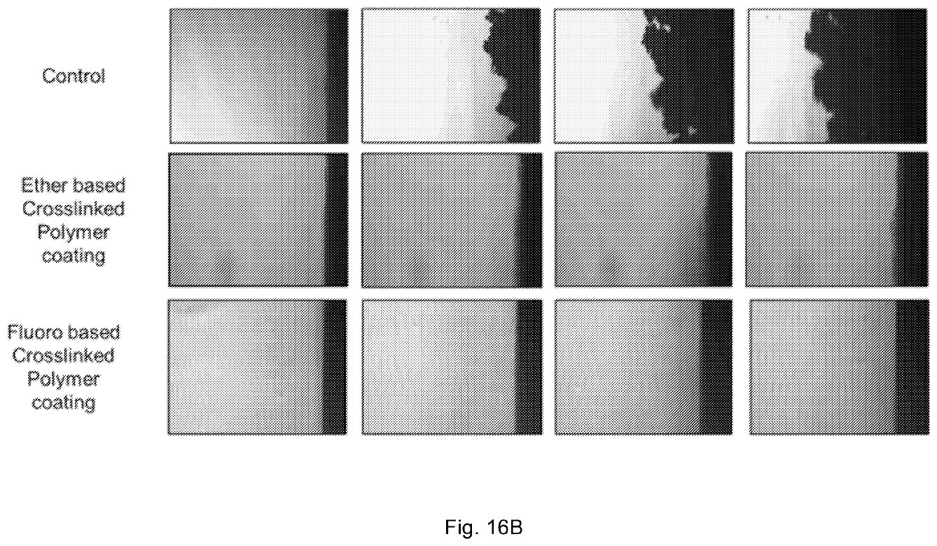

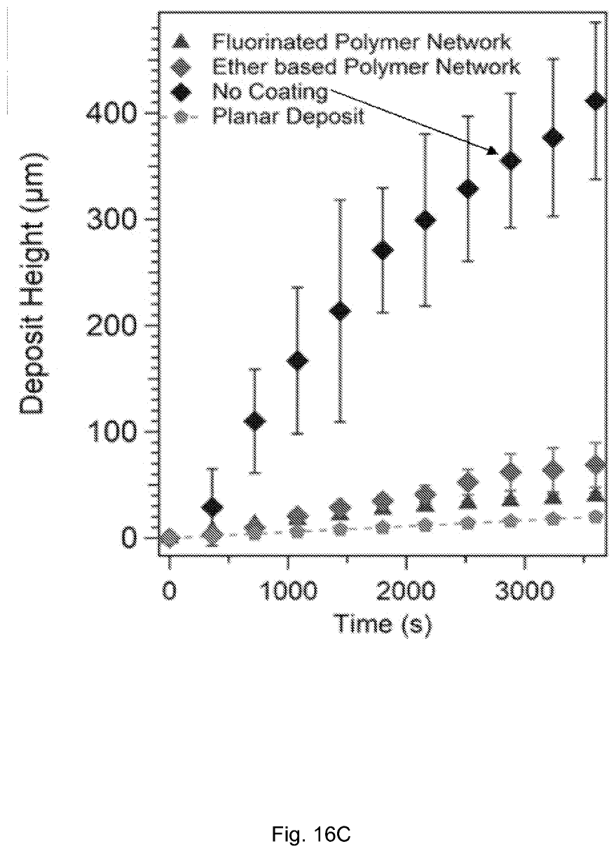

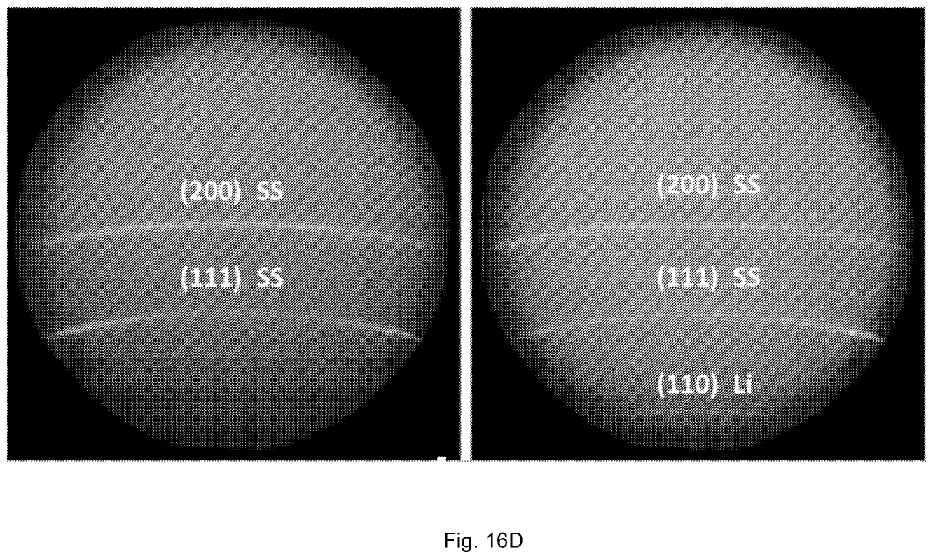

Visualization of lithium deposition was performed in a custom-designed apparatus that facilitates in-situ monitoring of the Li electrodeposit morphology using optical microscopy. FIG. 16A shows the results from a visualization experiment performed at a current density of 4 mA/cm². All cells used 1M LiPF₆ in EC/DMC as the bulk electrolyte. The bulk morphology of deposited lithium is consistently different under the influence of a polymeric interphase as compared to the no coating case. The average electrodeposit thickness was further analyzed using Matlab to gain insight into the evolution of lithium electrodeposition. Multiple points on the propagating front were tracked and averaged to obtain plots of the deposit height and growth rate over time for the ether-based coating, fluorinated coating and no coating case. (FIG. 16B). Comparing to what would be expected from a completely planar deposit, it is evident that the fluorinated polymer results in a close-to planar deposition of lithium metal, followed by the ether-based polymer which results in slightly higher values of deposit thickness. The deposited electrode surface was imaged by Scanning Electron Microscopy and provides ample evidence for the direct correlation between shear modulus and the deposit morphology (FIG. 16C).

Grazing Incidence X-Ray Diffraction (GIXRD) analysis was used to characterize the crystallography of the electrodeposited Li metal. FIG. 16D shows two dimensional GIXRD patterns for Li deposited on bare and fluoropolymer-coated (3T10F) polished stainless-steel substrates. A fixed deposit capacity of 5 mAh/cm², approximately 25 μm of Li was used in both cases and no-separator was employed in either case; the electrolyte was instead filled in an O-ring between the two electrodes. For lithium deposited on bare stainless steel, no diffractions associated with Li crystallites are detected. Considering the large amount of Li deposited, it was concluded that most of the deposited lithium is either covered by a thick SEI or is dead lithium lost during washing with solvent during sample preparation. For the lithium deposited on the coated substrate a clear and continuous (110) ring is detected, indicating the integrity and freshness of the deposited lithium and the lack of anisotropy possibly reflecting the grain boundaries observable in the deposited lithium. Thus, it can be inferred that the planarizing effect for the deposited metal in the growth regime increases with increasing elastic stresses at the electrode surface, consistent with theoretical results detailed above.

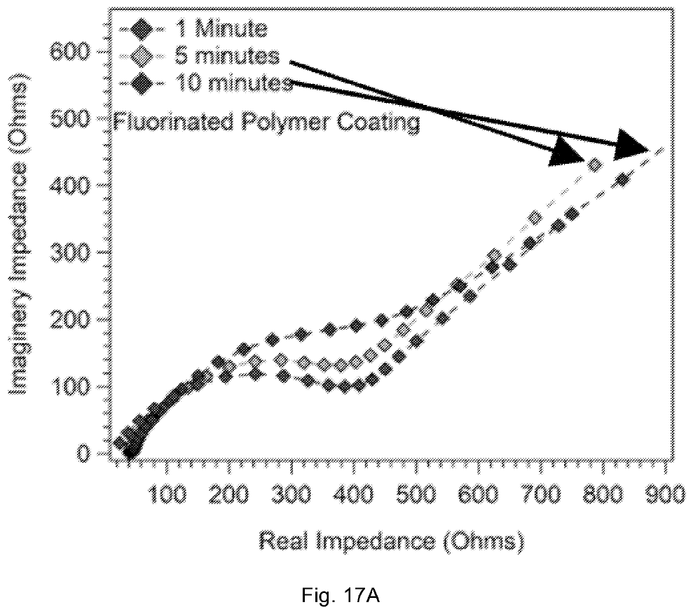

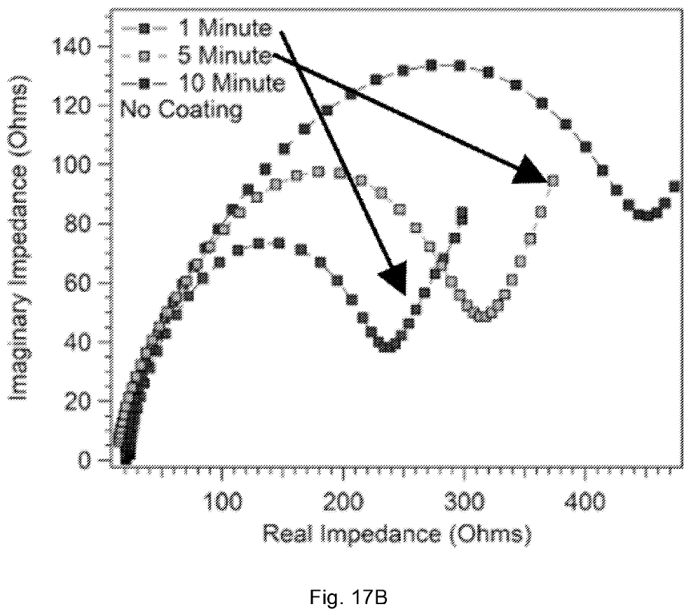

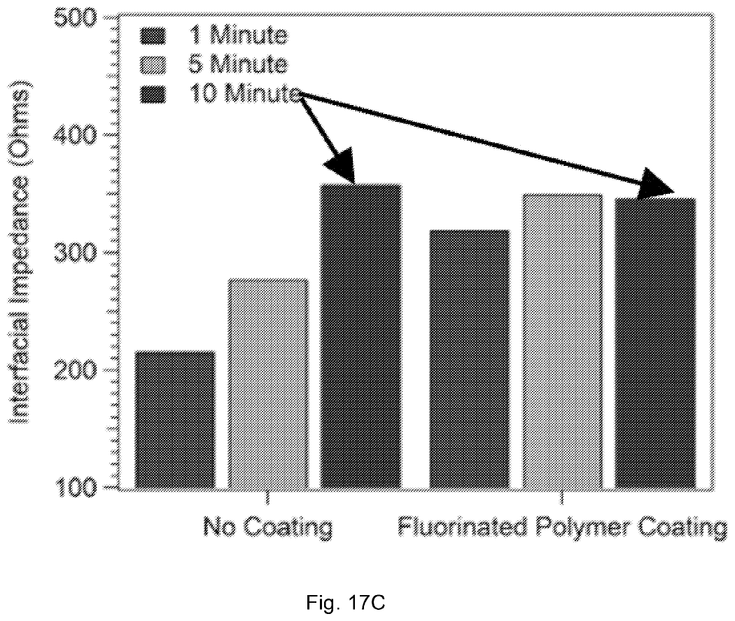

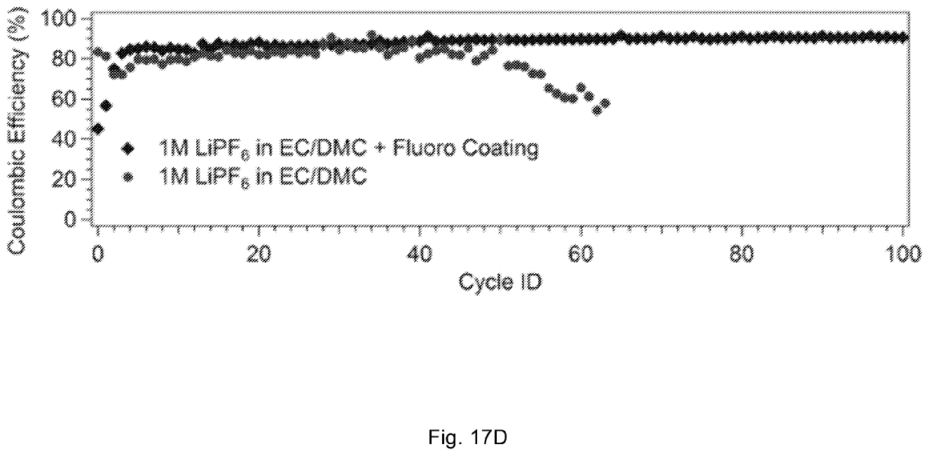

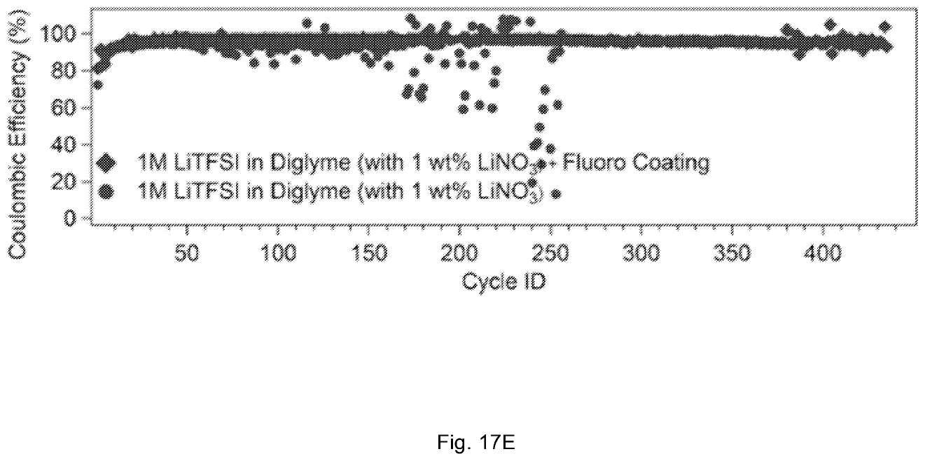

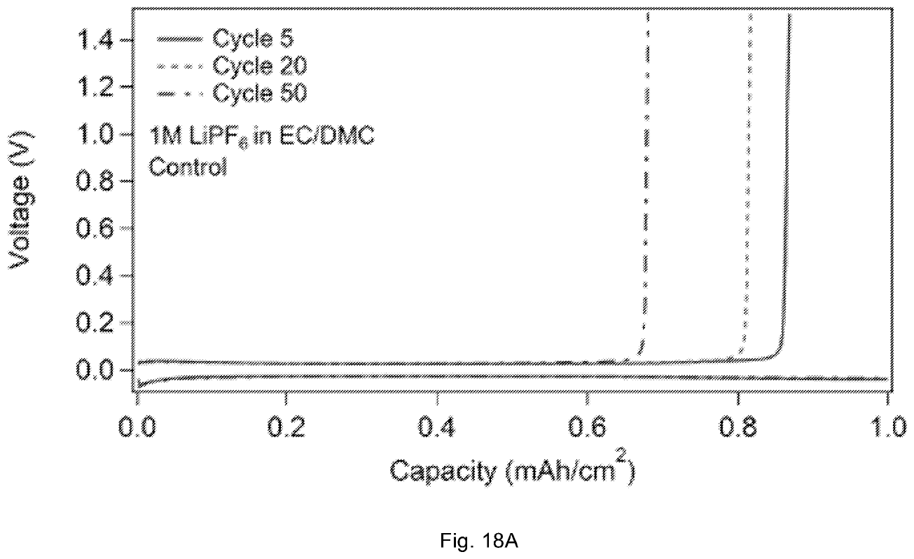

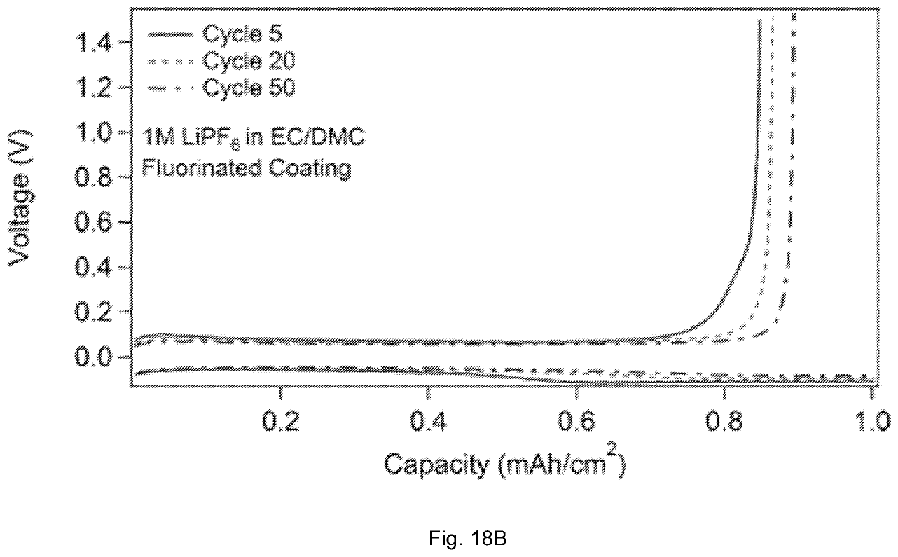

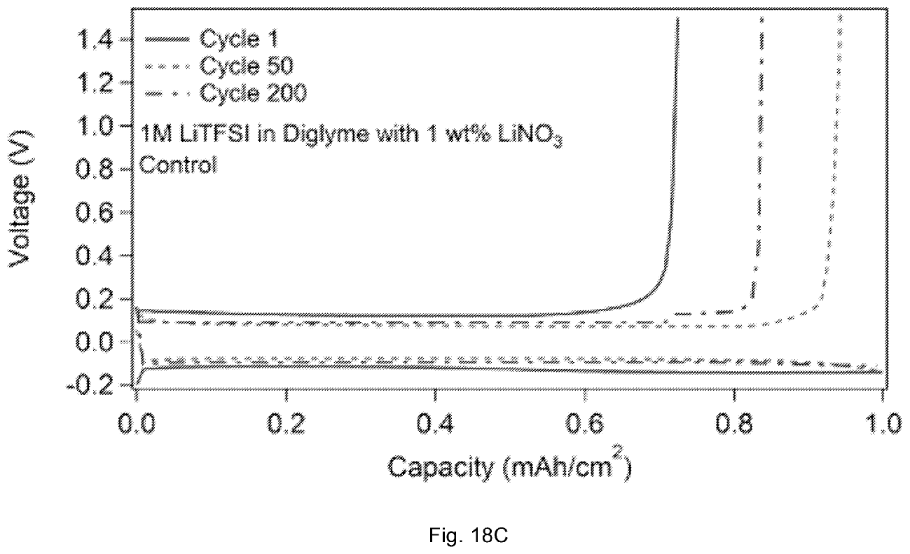

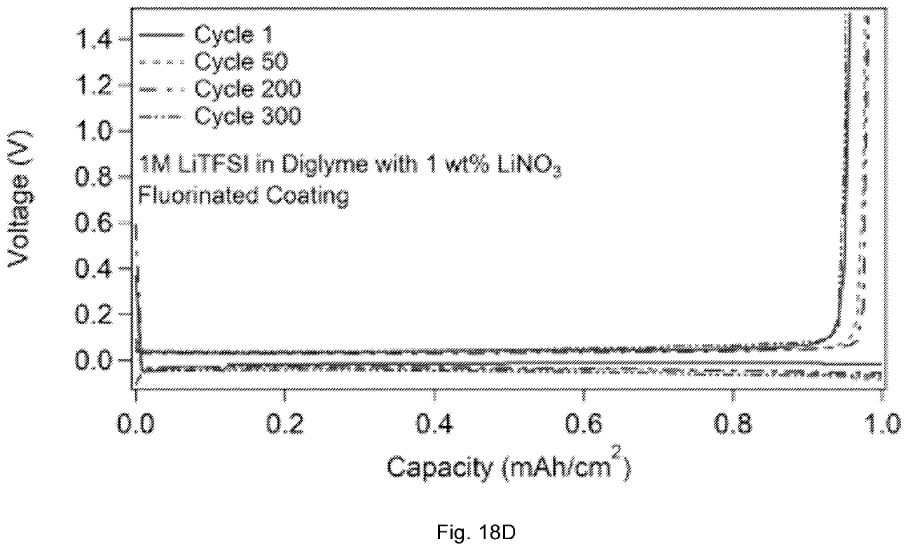

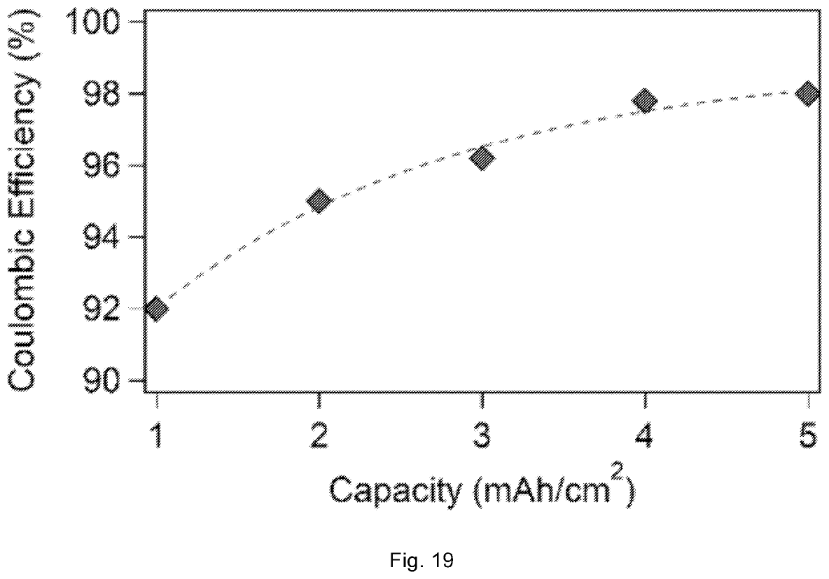

The long-term electrochemical stability and reversibility of Li electrodeposition on substrates protected with fluorinated polymer interphases at the optimal coating thickness established in FIGS. 3A-3C were evaluated. It is presumed that the polymer coating acts as a barrier to side reactions between the lithium metal and the bulk liquid electrolyte. To validate this hypothesis, chronoamperometry experiments were performed, whereby the cell was held at a fixed voltage (−50 mV) to facilitate reduction reactions at the working electrode surface. A fixed amount of lithium (0.1 mAh/cm²) was pre-deposited on coated and uncoated electrodes prior to testing and impedance of the cells were measured after potentiostatic holds at −50 mV for 1, 5 and 10 minutes. The extent of increase in impedance directly correlates to the extent of side reactions at the electrode. FIGS. 17A-17B show the impedance spectra of the coated and uncoated cells and the fitted spectra yielded the interfacial impedance values shown in FIG. 17C. In case of the uncoated electrode, the initial impedance value is lower than that of the coated electrode for small periods of potentiostatic hold. However, as the time period increases, the interfacial impedance increases by few factors, indicating side reactions with the bulk electrolyte over time. In case of the coated electrode, the interfacial impedance shows no change to minimal change, thus proving that the coating acts a protective barrier that reduces the extent of side reactions. This has important implications on long term stability of the anode, and in order to gain more insight, coulombic efficiency of coated and bare anodes paired with different classes of electrolyte were measured. The current density was fixed at 0.5 mA/cm² for a capacity of 1 mAh/cm². The voltage profiles for the corresponding tests are shown in FIG. 18. In case of the baseline electrolyte (FIG. 17D), it can be observed that the long-term stability is significantly enhanced in the presence of the fluorinated coating as compared to the bare electrode. However, the overall efficiency of the coated cell was still noted to be similar to the initial efficiency of the cell with no coating. The coated electrodes were tested against an ether-based electrolyte (under same conditions) that is known to have intrinsically good plating/stripping efficiency in the presence of a small amount of LiNO₃ (FIG. 17E). It was found that the coating significantly improves the lifetime of the cell, exceeding 400 cycles while maintaining a high coulombic efficiency of >98%. This shows that the coating indeed serves to enhance the electrochemical stability of the lithium metal anode against the bulk liquid electrolyte during long periods of operations. To test the ability of the coatings to accommodate large capacities of lithium, different amounts of lithium were deposited and stripped under the coating in a carbonate electrolyte with 10% Fluoroethylene carbonate additive. Consistent with previous reports, it was found that the coulombic efficiency per cycle increased with increasing capacity of lithium, reaching around 98% for a capacity of 5 mAh/cm² (FIG. 19). This further validates the coating's ability to host large amounts of lithium relevant for practical cell configurations.

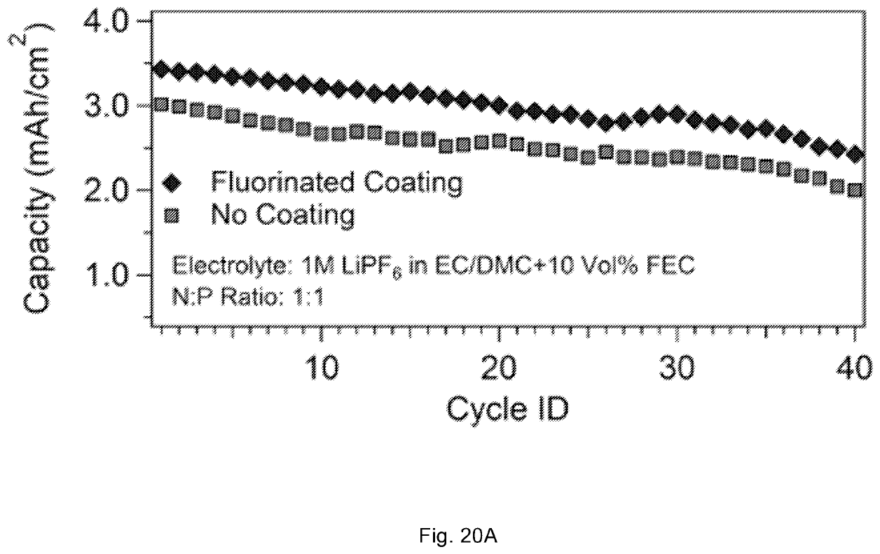

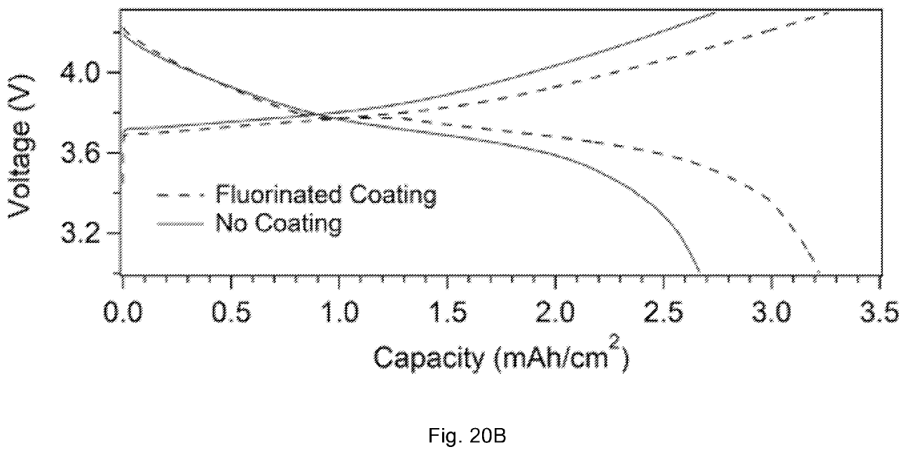

Finally, to evaluate the practical relevance of the fluorinated polymer interphases in batteries, NCM 622 (Capacity˜3.5 mAh/cm²)—Li cells were created and their cycling behaviors under galvanostatic conditions studied. The anode used for these cells was created by lithiating polished stainless steel substrates (with/without the fluoropolymer coatings) to achieve anodes with Li capacity equal to that of the cathode (3 mAh/cm²), in order to achieve a N:P ratio of around 1. It is worth noting that this is a more aggressive mode of testing the efficiency of full cells since there is an intrinsic porosity for the lithium formed via deposition as opposed to stre-bought thin lithium anode. The electrolyte used for both the lithiation step and for assembling the full cells was 1M LiPF₆ in EC/DMC with 10% FEC. FIG. 20A shows the capacity as a function of cycle number and FIG. 20B shows the voltage profiles for the tenth cycle. The capacity retention in the full cells employing coated electrodes is superior to the uncoated case, consistent with our previous measurements and results.

The effect of fluorinated polymeric coatings on the morphology and growth rate of electrodeposited metal were studied. The physical properties of the interfacial layer have a profound effect on the deposit size at the initial stages of deposition. It is found that there exists an optimum thickness for the coating for the most stable deposition due to an interplay between elasticity and diffusivity. By varying the length of the fluoro-alkyl side chains, the surface energy of the polymer was varied systematically without considerably changing other properties of the system. The surface energy of the coating was seen to have a noticeable effect on the deposit size, although the morphology was similar in all the cases. The effect of elasticity was also probed by studying two polymer coatings of different shear modulus values and it was found that there was a strong correlation between growth rate of metal deposits captured from visualization experiments and the modulus of the polymer coating. These results were further validated by a linear stability analysis that models parameters of the interfacial layer like thickness, resistance and interfacial tension and their subsequent influence on the growth rate of the deposits. This elucidates the strong dependence of nucleation and growth of reactive metals on the physical properties of an elastic interfacial layer between the electrode and electrolyte. These parameters should be considered thoroughly in designing artificial SEIs or electrolytes that result in specific compositions of the SEI. Additional studies on effect of such polymeric interphases during the earliest nucleation phase and at different current densities of operation are vital for a complete understanding of their effects and laying out the design principles for polymeric coatings that enable dendrite free metal anodes.

Section I. Stability analysis of electrodeposition at a metal electrode coated with a cross-linked polymer coating. An electrochemical cell with inter-electrode distance L with an elastic coating of thickness h<<L on the metal electrode and an “outer” liquid electrolyte filling the remainder of the inter electrode space, L−h was considered. The cationic and anionic diffusivities in the outer electrolyte are denoted by D_{c}^{o} and Dₐ^{o}. In the coating, the diffusivities are denoted by D_{c}ⁱ and Dₐⁱ. The equilibrium salt concentration is C₀. For simplicity, volume changes associated with the Li transport in the outer electrolyte and in the interface layer were not considered and consequently set the partial molar volumes of the ions in each to zero, i.e. v_{c}^{o}=vₐ^{o}=v_{c}ⁱ=vₐⁱ=0. The elastic shear modulus of the cross-linked polymer network, G^{s}, is assumed to be much smaller than that of the metal electrode, i.e., G^{s}<<G^{m}. This assumption is supported by results obtained from oscillatory shear rheology measurements (FIG. S10 using thicker versions of the coatings). Here G^{m} is the elastic shear modulus of the Li metal deposit, which is at least 1 GPa at the conditions of our study. Finally, because of the high surface tension of Li relative to any of the other components, the interfacial tension of the polymer-liquid electrolyte interface were ignored and only consider the interfacial tension of the metal-polymer interface.

The concentration field is then obtained as,

$$C = {C}_{c 0} + \frac{J}{2 {FD}_{c}^{i}} z z < h \qquad ( S - 1 )$$

$$C = {C}_{c 0} + \frac{J}{2 {FD}_{c}^{i}} h + \frac{J}{2 {FD}_{c}^{o}} ( z - h ) z > h \qquad ( S - 2 )$$

The salt concentration at the electrode is

$${C}_{c 0} = {C}_{0} ( 1 - \frac{J}{{J}^{*}} ) ,$$

where J* is the diffusion-limited current density given by,

$${J}^{*} = {\frac{4 {D}_{c}^{o} {FLC}_{0}}{{( L - h )}^{2}} [ \frac{h ( 2 L - h ) {D}_{c}^{o}}{{( L - h )}^{2} {D}_{c}^{i}} + 1 ]}^{- 1}$$

The governing equations for elastic deformation of the interfacial layer are identical to those previously reported. During the early stages if deposition, the deformation of the cross-linked coating is small and its stress response can be modelled as a Hookean solid,

σ^{s}=(2α^{s}−1)G^{s}∇·uₛI+G^{s}[∇u^{s}+(∇u^{s})^{T}]. (S-3)

The force balance for the elastic layer then becomes,

∇²u^{s}+2α^{s}∇(∇·u^{s})=0. (S-4)

Here α^{s}=[2(1−2v^{s})]⁻¹ where v^{s} is the Poisson's ratio.
The deformation of the metal electrode is neglected due to the assumption that the interfacial layer has a much lower modulus than the electrode. This means that the boundary conditions on the deformation field on the interfacial layer are,

n^{ms}·u^{s}=H (S-5)

(I−n^{ms}n^{ms})·u^{s}=0 (S-6)

n^{sl}·σ^{s}=0. (S-7)

where n^{sl} and n^{ms} are normal vectors to the film-liquid and the metal-film interfaces respectively, pointing into the latter phase. The first two boundary conditions stem from the stipulation that the metal is rigid compared to the interfacial layer. Consequently, the displacement of the metal-film interface directly yields the deformation in the interfacial layer. The latter boundary condition results from a force balance on the film-liquid interface and is the consequence of ignoring the interfacial tension of that interface. In the base state of a flat metal surface, the interfacial layer and the electrode are not deformed, and the deformation field yields a trivial result.

The concentration and deformations were perturbed with sinusoidal perturbations as in previous work, with and a specified wavenumber k and an arbitrarily small amplitude that grows exponentially with a growth rate σ. The amplitude of the perturbation to the metal-polymer interface is arbitrarily taken to be unity. The sign of the growth rate determines the stability of deposition, with a positive sign corresponding to unstable deposition and a negative sign indicating a stable planar interface. Solving the perturbed equations yields,

$$σ = \frac{{kv}_{m}}{F} [ J ( \frac{1 + D θ}{D + θ} + {h}^{′} \frac{D - 1}{D + θ} ) - \frac{{D}_{c}^{i} {v}_{m} {FC}_{c 0}}{RT} \frac{1 + D θ}{D + θ} {P}^{′} ]$$

$${Z}_{1} = - 4 k {α}^{s} \frac{kh {θ}^{2} + θ - kh}{{( 1 + 2 {α}^{s} )}^{2} + {( 2 {α}^{s} kh )}^{2} - {θ}^{2} [ 1 + {( 2 {α}^{s} kh )}^{2} ]}$$

$${Z}_{0} = \frac{2 k θ + {Z}_{1} [ 1 + 2 {α}^{s} - 2 {α}^{s} kh θ ]}{2 {α}^{s} kh + θ}$$

$${h}^{′} = 1 - {α}^{s} {Z}_{0} h θ + {Z}_{1} \frac{θ}{k} [ 1 + {α}^{s} - {α}^{s} \frac{kh}{θ} ]$$

$${P}^{′} = \frac{2}{3} ( 1 + {v}^{m} ) [ γ {k}^{2} + {G}^{s} \{ 2 k - ( {Z}_{0} + {Z}_{1} ) ( 1 + 2 {α}^{s} ) \} ]$$

with θ=tan h(kh) and D=D_{c}ⁱ/D_{c}^{o}, which together give the stability of the perturbation. The wavelength of the least stable mode (kₘₐₓ) corresponds to the preferred size of the deposits, and is obtained by maximizing σ with respect to k.

Section II. Supporting Data and Analysis. 1. Materials and Synthesis Protocols: 2,2,3,3,4,4,5,5,6,6,7,7-Dodecafluoroheptyl acrylate, 2,2,3,3,4,4,4-Heptafluorobutyl acrylate, 2,2,2-Trifluoroethyl acrylate, Diethylamine, Pentaerythritol tetrakis(3-mercaptopropionate) and 1,3,5-Triallyl-1,3,5-triazine-2,4,6(1H,3H,5H)-trione were purchased from Sigma Aldrich and used without further purification. A typical synthesis scheme used to synthesize the fluorinated coatings is as follows: Pentaerythritol tetrakis(3-mercaptopropionate) was added to a round bottom flask along with 2 mol % of Diethylamine. The mixture was degassed with argon to remove any oxygen present. This was then taken into a glovebox with <1 ppm O₂ and <1 ppm H₂O and under mild stirring, 2,2,2-Trifluoroethyl acrylate was added at a rate of 1 ml/min. The reaction then proceeded overnight under inert atmosphere and a dark environment (For larger fluoroalkyl side chains, toluene was added to the mix to improve miscibility). The prepared crosslinker was then used without further purification (except for removal of toluene) and was mixed with 1,3,5-Triallyl-1,3,5-triazine-2,4,6(1H,3H,5H)-trione in a 1:1 ene:thiol molar ratio and 0.5 wt % Benzophenone. This was dissolved in a choloroform:ethanol solvent mixture (1:1 volume ratio) before spincoating to form coatings of desired thicknesses. Lithion™ was obtained from Ion Power and spincoated on the stainless-steel substrates as received. Poly(ethylene glycol) diacrylate (MW=480) was obtained from Sigma Aldrich and coated using a similar procedure as described above. 1M LiPF₆ in EC/DMC (50/50 by Volume), Diethylene Glycol Dimethyl Ether, Lithium Nitrate and Lithium bis(trifluoromethanesulfonyl)imide were obtained from Sigma Aldrich. Lithium foil was obtained from Alfa Aesar and NCM 622 was provided by NOHMS Technologies.

Methods Material Characterization: All air and water sensitive manipulations were carried out under dry argon conditions in an MBraun Labmaster glovebox.

NMR: ¹³C NMR were collected on a Bruker AV III HD (13C, 125 MHz) spectrometer with a broad band Prodigy cryoprobe.

FTIR: FTIR spectra were recorded in Cornell Energy Systems Institute (CESI) using Nicolet iz10.

DSC: Differential Scanning Calorimetry (DSC) was done at CESI using TA Instrument (Model: Q500). Samples were first scanned to 150° C. at a rate of 20° C./min and then cooled to −100° C. at a rate of 5° C./min. A subsequent heating cycle was done at a rate of 10° C./min till 150° C. and this heating cycle was used to analyze the Glass transition temperatures of the samples.

Rheology: Oscillatory shear measurements were performed using a MCR301 (Anton Paar) rheometer at Cornell Energy Systems Institute (CESI) equipped with a 10 mm parallel plate fixture. A low strain rate of 0.1% was used for the frequency sweeps to remain in the linear viscoelastic regime.

The thickness of the coatings were measured in Cornel Center for Materials Research using a Tencor AlphaStep 500 profilometer.

Ionic conductivity and impedance measurements as a function of temperature were measured at Cornell Energy Systems Institute (CESI) with a Novocontrol N40 broadband spectrometer fitted with a Quarto temperature control system.

Surface Energy Calculations: An Attention Theta-lite Optical tensiometer (Biolin Scientific) was used in an argon-filled glove box for obtaining the contact angle data. The contact angles (C.A.) were measured according to the sessile drop method at room temperature (20° C.). A single drop of the test liquid (drop volume ca. 4-5 μL) was placed on the sample via a microliter syringe. Dynamic contact angles were measured from the optical image of the steady droplet using the live acquisition mode of the software. The initial few dynamic Contact angle readings at the start of an experiment were discarded owing to unsteady state of the droplet (Advancing/Receding contact lines). Surface energy was calculated using the Owens-Wendt method. The contact angle of both water and diiodomethane was measured on polymer films spin coated on stainless steel. Using the below equation,

$$\frac{1 + cos θ}{2} \frac{{γ}_{liquid}}{\sqrt{{γ}_{liquid}^{dispersive}}} = \sqrt{{γ}_{polymer}^{polar}} \frac{\sqrt{{γ}_{liquid}^{polar}}}{\sqrt{{γ}_{liquid}^{dispersive}}} + \sqrt{{γ}_{polymer}^{dispersive}}$$

one can construct a linear plot whereby the slope and intercept gives dispersive and polar components of the surface energy of the polymer.

Polishing/cleaning method: The stainless-steel 304 substrate was polished to a surface roughness of Ra<10 nm through chemical mechanical polishing (CMP) method. The unpolished stainless steel substrates were fixed in an Alumina slurry of 0.3 Micron particles on a bed of Final-POL Adhesive Back Disc (Allied High Tech products) in a vibratory polisher at an amplitude of 50% for about 2 days. The polished stainless-steel substrates were cleaned through ultrasonication in a bath of acetone for about 1 hour.

Electrode Characterization: 2032-type coin cells with the polished stainless-steel working electrodes and Li foil (Alfa Aesar 0.75 mm width) counter electrodes were assembled in an argon-filled glove box (MBraun). A Teflon O-ring of internal diameter 0.25 inches was used between the two electrodes and 200 μL of electrolyte was added to each cell. Celgard 3501 separator was used for Coulombic Efficiency and Full cell tests. Galvanostatic deposition was conducted using an 8-channel battery testing unit from Neware Instruments and MACCOR series 4000 battery tester system. For studying the early stage growth, the stainless-steel electrode was discharged to 0 V vs. Li/Li+ by applying 0.5 mA/cm2 current, then charged back to 1.5 V at −0.5 mA/cm2 to initialize SEI formation and remove surface impurities. Then, a fixed amount of charge was passed galvanostatically at different current rates depending on the experiment. After Li electrodeposition onto stainless-steel, the cells were opened in the Argon glove box and the stainless-steel electrodes were rinsed with fresh Dimethyl Carbonate/Diethylene Glycol Dimethyl Ether and dried. Electrodes were mounted onto SEM stages and sealed in Argon filled transfer vessels for immediate SEM observation. Unavoidable contact with air was brief and may have slightly altered the surface features of the electrodeposited Lithium metal seen in SEM images. The images were captured at 2 kV with an aperture of 20 μm. Image/Data Analysis: Nuclei sizes were measured using ImageJ software. Gaussian blurring to remove excessive noise, Thresholding to restrict color contrast of images to black and white, and adjustable watershed to identify nuclei were performed. Between 100-500 particles were averaged for each current density and for every electrolyte composition. The radius of a Nuclei was calculated by assuming the nuclei to be hemispherical and the projected area was approximated to that of a circle.

### Example 2

The following example includes further imaging performed on the fluorinated polymer coatings of the present disclosure.

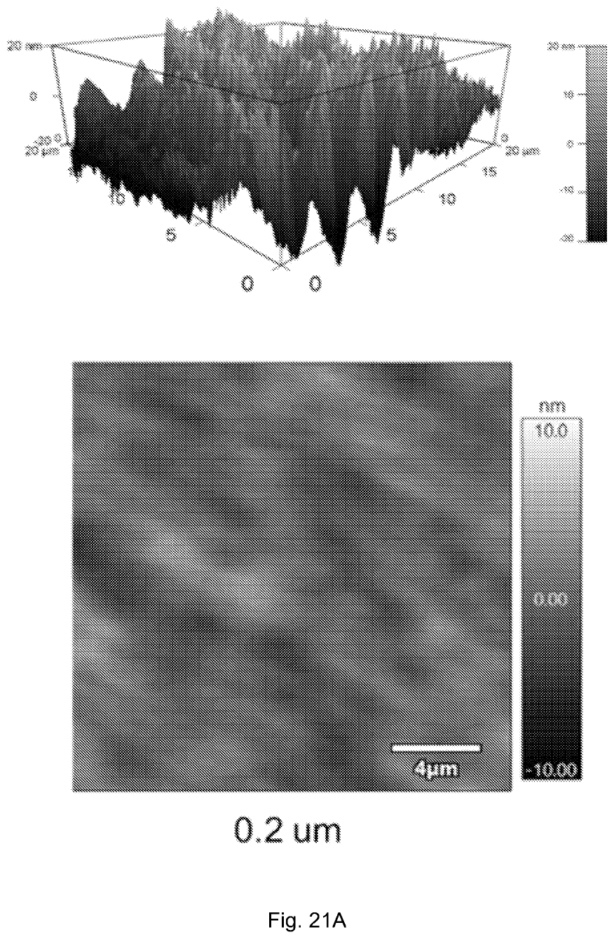

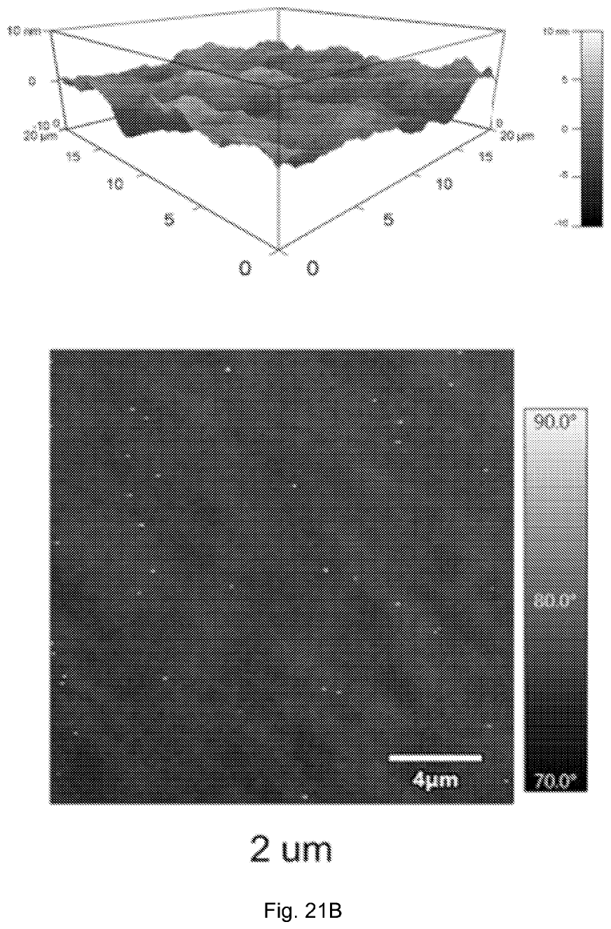

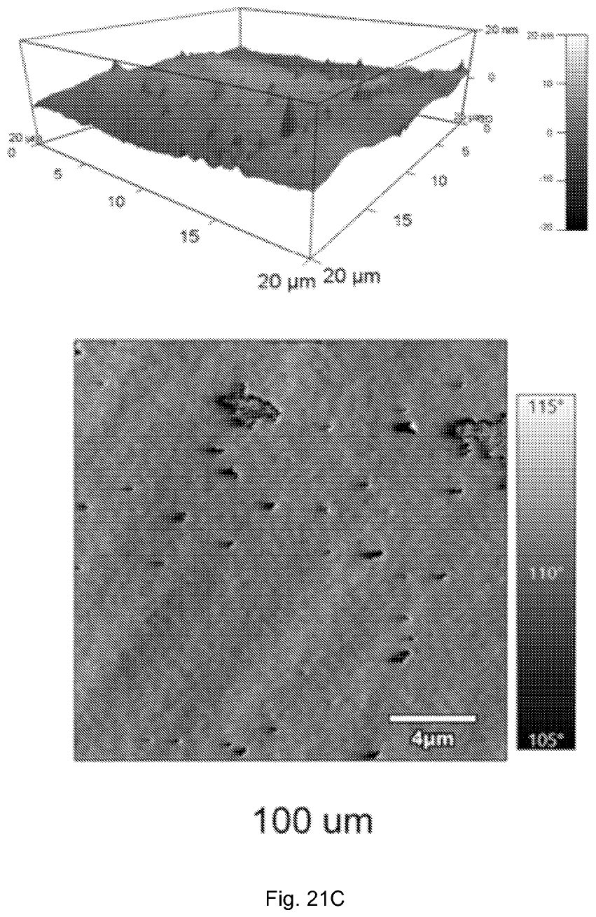

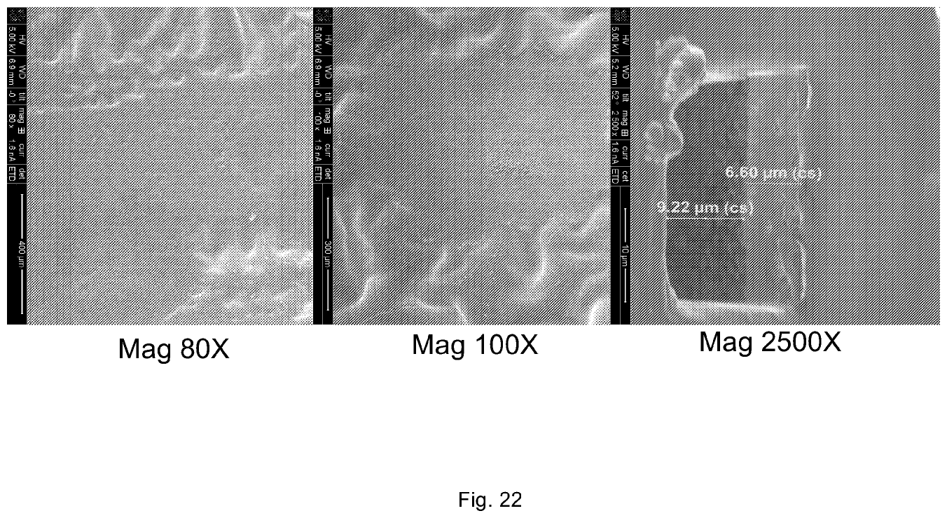

Functionalized cross-linked polymer networks and coatings were formed as generally described in Example 1. FIGS. 21A-21D show AFM imaging of fluorinated cross-linked polymer network coatings of varying thicknesses: (21A) 0.2 μm, (21B) 2 μm, and (21C) 100 μm. FIG. 22 shows Cryo-Fib imaging of lithium deposit under a fluorinated cross-linked polymer network coating.

### Example 3

This example describes functionalized cross-linked polymer networks of the present disclosure. The example also describes methods of making functionalized cross-linked polymer networks and uses thereof.

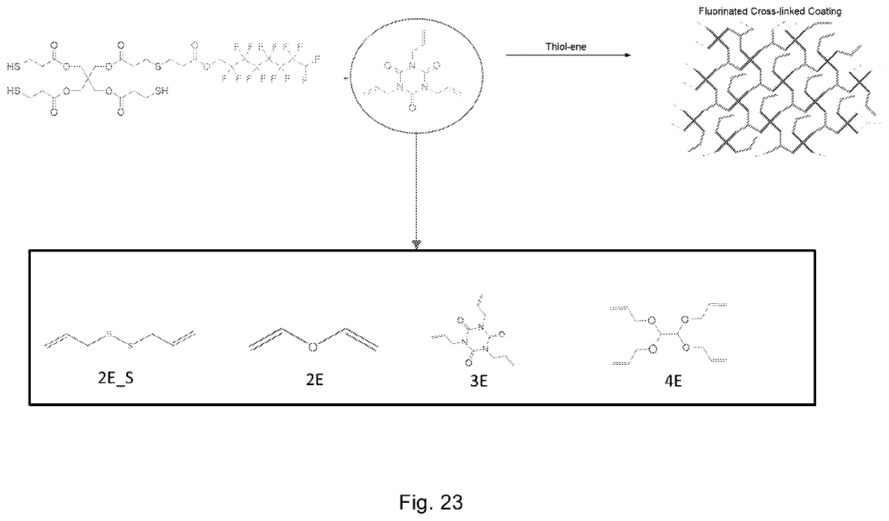

Li electrodeposition was investigated using coatings with different shear modulus values using different multifunctional monomers group by switching the chemistry in step 2 of the synthesis protocol described in Example 1 (FIG. 23). The reactive ends of multifunctional monomers were tuned by modifying step 2 in the synthesis of functionalized monomers. Functionalized cross-linked polymer networks and coatings were formed as generally described in Example 1. In FIG. 23, the functionalized monomers and multifunctional monomers are combined with benzophenone (0.5 wt %) in a solvent, spin coated on a current collector, and irradiated with 380 nm UV light at 22° C. By varying the number of reactive ends and bond chemistry, the crosslink density and shear modulus of the networks can be varied systematically. The correlation between the nuclei size and coating modulus measured by DMA is presented in Table 2 and agrees with theoretical predictions.

TABLE 2
Surface energy, shear modulus of coatings with different
multifunctional monomers and corresponding lithium nucleate sizes.

| | Surface Energy | Shear Modulus | Nucleate Size |
|---|---|---|---|
| Multifunctional monmer | (mJ/m²) | (Mpa) | (μm) |
| 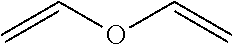 | 28 | 0.1 | 1.1 |
| 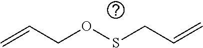 | 29 | 0.7 | 1.44 |
| 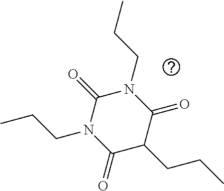 [SMILES: CCCC1C(=O)N(CCC)C(=O)N(CCC)C1=O] | 30 | 6 | 3.4 |
| 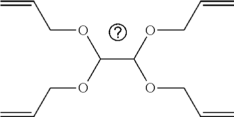 [SMILES: C=CCOC(OCC=C)C(OCC=C)OCC=C] | 30 | 10 | 3.55 |

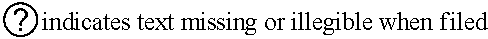

Although the present disclosure has been described with respect to one or more particular examples, it will be understood that other examples of the present disclosure may be made without departing from the scope of the present disclosure.

1. A functionalized cross-linked polymer network comprising:
a plurality of cross-linked multifunctional trione triazine groups, a plurality of disulfide groups, a plurality of cross-linked multifunctional ether groups, a plurality of cross-linked multifunctional polyether groups, or a combination thereof;
a plurality of crosslinking multifunctional polyether groups; and
a plurality of dangling groups,
wherein individual cross-linked multifunctional trione triazine groups and/or individual cross-linked multifunctional disulfide groups and/or individual cross-linked multifunctional ether groups and/or individual cross-linked multifunctional polyether groups and individual crosslinking multifunctional polyether groups are connected by one or more covalent bond(s) and individual dangling groups are connected to a multifunctional trione triazine group and/or a cross-linked multifunctional disulfide group and/or a cross-linked multifunctional ether group and/or a cross-linked multifunctional polyether group and/or a crosslinking multifunctional polyether group by a covalent bond.

2. The functionalized cross-linked polymer network of claim 1, wherein individual cross-linked multifunctional trione triazine groups and/or cross-linked multifunctional disulfide groups and/or cross-linked multifunctional ether groups and/or cross-linked multifunctional polyether groups and individual crosslinking multifunctional polyether groups are covalently bonded to individual crosslinking multifunctional polyether groups by a thioether bond.

3. The functionalized cross-linked polymer network of claim 1, wherein the crosslinking multifunctional polyether groups are formed from multifunctional polyether monomers independently comprising one or more crosslinking group(s) and one or more dangling group(s).

4. The functionalized cross-linked polymer network of claim 1, wherein individual dangling groups are covalently bonded to individual crosslinking multifunctional polyether groups by a thioether bond.

5. The functionalized cross-linked polymer network of claim 1, wherein the multifunctional trione triazine groups have the following structure: 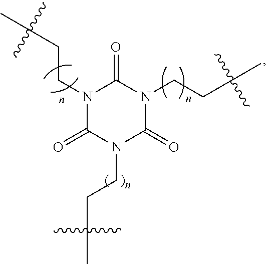
wherein n is independently 1-6, the cross-linked disulfide groups have the following structure: 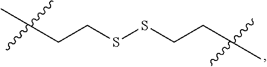 [SMILES: *CCSSCC*]
or the cross-linked ether groups have the following structure: 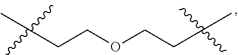 [SMILES: *CCOCC*]
or the cross-linked polyether groups have the following structure 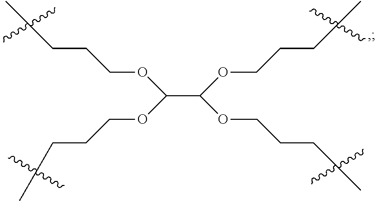 [SMILES: *CCCOC(OCCC*)C(OCCC*)OCCC*]
and/or
the crosslinking multifunctional polyether groups have the following structure: 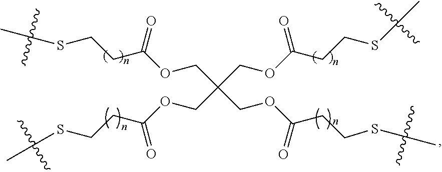
wherein n is independently 1-4.

6. The functionalized cross-linked polymer network of claim 1, wherein the dangling group(s) is/are independently chosen from perfluorinated carbon groups, fluorinated polyethylene glycol groups, fluorinated polydimethyl siloxane (PDMS) groups, and combinations thereof.

7. The functionalized cross-linked polymer network of claim 1, wherein the network exhibits a shear modulus range of 100-0.1 MPa, 50-1 MPa, or 10-1 MPa, including all 0.1 MPa values and ranges therebetween, and/or a tan 6 range of 1:50 to 1:1, including all 0.1 tan 6 values and ranges therebetween.

8. A method of preparing a functionalized cross-linked polymer network coating on a substrate, the method comprising:
forming a coating on a substrate comprising:
one or more functionalized polyether monomer(s);
one or more multifunctional monomer(s);
optionally, one or more polymerization initiator(s); and
optionally, one or more solvent(s); and
exposing the coating to electromagnetic radiation, when the polymerization initiator(s) is/are photoinitiator(s), and/or heating the coating and/or allowing the coating to stand under ambient conditions, such as to initiate covalent bonding between individual functionalized polyether monomer(s) and individual multifunctional trione triazine monomer(s), thus forming the functionalized cross-linked polymer network coating.

9. The method of claim 8, wherein the functionalized polyether monomer(s) is/are chosen from 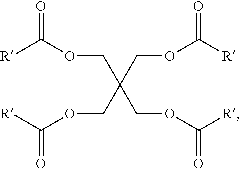
wherein R′ is independently chosen from dangling groups, thiol groups, and alkenyl groups, and 1, 2, or 3 of the R′ groups are dangling groups.

10. The method of claim 8, wherein at least a portion of the functionalized polyether monomer(s) independently comprise dangling group(s) chosen from perfluorinated carbon groups, fluorinated polyethylene glycol groups, fluorinated polydimethyl siloxane (PDMS) groups, and combinations thereof.

11. The method of claim 8, wherein the multifunctional monomers are chosen from multifunctional trione triazine monomers, multifunctional disulfide monomers, multifunctional ether monomers, multifunctional polyether monomers, and combinations thereof.

12. The method of claim 8, wherein the multifunctional monomers are multifunctional trione triazine monomer(s) chosen from 1,3,5-triazine-2,4,6(1H,3H,5H)-trione monomers and combinations thereof.

13. The method of claim 8, wherein the solvent(s) is/are chosen from organic solvents, liquid electrolyte(s), solid electrolyte(s), or combinations thereof.

14. The method of claim 8, wherein the polymerization initiator(s) is/are chosen from photoinitiator(s), thermal initiator(s), redox initiator(s), nucleophilic catalyst(s), base catalyst(s), or combinations thereof.

15. An anode for a metal ion-conducting electrochemical device comprising
a metal member; and
a coating disposed on at least a portion of the metal member, wherein the coating comprises one or more functionalized cross-linked polymer network(s) of claim 1.

16. The anode of claim 15, wherein the metal member is chosen from lithium metal members, sodium metal members, potassium metal members, magnesium metal members, or aluminum metal members.

17. The anode of claim 15, wherein the thickness of the functionalized cross-linked polymer network is 0.1 to 100 microns.

18. A device comprising one or more functionalized cross-linked polymer network(s) of claim 1.

19. The device of claim 18, wherein the one or more functionalized cross-linked polymer network(s) are formed in situ in a device.

20. The device of claim 18, wherein the device comprises a liquid electrolyte or a solid electrolyte.

21. The device of claim 18, wherein the device is a battery, a supercapacitor, a fuel cell, an electrolyzer, or an electrolytic cell.

22. The device according to claim 18, wherein the device is an alkali metal- or alkaline earth metal-ion conducting liquid- or solid-state battery, the anode comprises an alkali metal or alkaline metal.

23. The device of claim 18, wherein the device is a battery further comprising:
a cathode; and
optionally, a separator.

24. The device according to claim 23, wherein the cathode comprises a material chosen from alkali metal-containing, alkaline earth metal-containing, or conversion type cathode materials.

25. The device according to claim 23, wherein the cathode comprises a conducting carbon material and a cathode material.

26. The device according to claim 23, wherein the device further comprises a liquid electrolyte, which is in contact with the functionalized cross-linked polymer network.

27. The device according to claim 23, wherein the cathode, anode, and, optionally, a current collector form a cell, and the battery comprises a plurality of the cells and each adjacent pair of the cells is separated by a bipolar plate.
